(19) United States
(12) Patent Application Publication
(10) Pub. No.: US 2002/0022976 A1
(43) Pub. Date: Feb. 21, 2002

(54) Method and system for providing online insurance information

(76) Inventor: William R. Hartigan, Littleton, CO (US)

Correspondence Address: DORSEY & WHITNEY, LLP, SUITE 4700, 370 SEVENTEENTH STREET, DENVER, CO, 80202-5647, US

(21) Appl. No.: 09/862,577

(22) Filed: May 21, 2001

Related U.S. Application Data
(60) Provisional application No. 60/205,477.

(51) Int. Cl. G06F 17/60

(52) U.S. Cl. 705/4

(57) ABSTRACT

A method and system for transferring, evaluating, tracking, and reporting insurance information over a network. The invention includes a database containing individual data fields storing insurance information, including various limits and coverage features for insurance policies. Agents may access the database either locally or across a network to enter insurance policy information for one or more insureds. Each insured is assigned at least one permanent access code and password combination. The insured or a corresponding certificate holder may access and view the insurance information using an access code and password combination. Further, an effective coverage date may be selected, and only insurance information valid as of that date will be displayed. The holder may specify a set of insurance requirements that all insureds in a relationship with the holder must meet. The holder may also create a compliance report and/or exception report in order to easily view a list of all insureds and their coverages, reported by insurance category. The compliance report and exception report may also display whether each insured's coverage meets the holder's requirements.

This invention claims priority to provisional application No. 60/204,477, entitled “INS-CERT.COM,” showing William R. Hartigan as inventor, and having a filing date of May 19, 2000 (the '477 application). The '477 application is hereby incorporated by reference as though fully disclosed herein.

### TECHNICAL FIELD

This invention relates generally to providing insurance information across a computer network, and more specifically to providing casualty and property information for an insured to a certificate holder across a global computer network such as the Internet.

### BACKGROUND OF THE INVENTION

When one business provides a service or product to a customer, the provider must often furnish proof of insurance, especially where the service or product creates a risk of injury or damage. For example, a contractor hired to build a building typically must carry workers compensation insurance to protect his workers and liability insurance in case a third party is injured due to the contractor's negligence.

Typically, such proof is furnished in the form of a certificate of insurance, (“COI”). The service provider, contractor, tenant, borrower, vendor, or other party, who is insured by the policies shown on the COI is commonly called the “insured” and the recipient is referred to as the “certificate holder” (or more simply, “holder”). COIs are issued by an insured's insurance agent, agency broker, or by insurance companies that do not use agents or brokers (collectively referred to as an “agent”). Many holders demand a certificate for each project or location on which an insured works, thus substantially multiplying the number of certificates required for a single insured/holder relationship. Each insured may need certificates for many holders, as in the case of a plumber working for several general contractors. The agent also will normally send a copy of the certificates to the insured, a copy to each insurance company shown on the COI, and will keep a copy in the file. When a certificate is rejected by a holder, it must be reissued and renewed each year when the policies renew, thus compounding the difficulty of issuing COIs. The number of certificates issued are estimated to exceed a billion each year, and in spite of increased efficiencies from computer-generated COIs, best estimates indicate a cost of over $10-$15 per certificate. Thus, over $10 billion per year is spent issuing COIs.

Further compounding the problem with COIs, a holder must manually review and evaluate each certificate individually. Since many holders do not employ insurance professionals, certificates showing inadequate coverage are not always discovered. Thus, many holders may be unknowingly exposed to liabilities that should have been covered by the insured's policies.

Most COIs are issued on a standardized computer-implemented form displaying five coverage sections: general liability, (“GL”), automobile liability (“AL”), garage liability, umbrella/excess liability (“UMB”), and workers compensation (“WC”). There is sometimes an “Other” section and a place for an agent to enter a “description of operations/locations/vehicles/special terms,” but these are typically limited to about 300 characters. There is no place to enter pollution liability, professional liability, or other less common coverages. This means that holders must look for and verify several coverages based on what is written in nonformatted sections, making evaluation more difficult. Also, a separate form is required for property and marine coverage certification. Several companies issue COls on variant forms, making evaluation more difficult for holders. Further, a paper COI can only be issued by a single agent, so a holder may receive two or more certificates from two or more agents for a single insured.

Once the holder evaluates the paper certificates, the information must be tracked so that the holder has a convenient reference to know which insureds carry what coverage, when each policy expires for renewal follow-up, and to share this information with others in the organization. Many large contractors, property managers, government agencies, manufacturers, retail chains, and others have home office risk management departments, branch offices, project or property managers and accounts payable departments who need to know that a contractor's insurance is in force and complies with the organization's requirements.

Additionally, an agent issuing a certificate of insurance typically promises only to endeavor to notify a holder if a policy is cancelled or changed. Many agencies lack the time or inclination to notify holders of policy cancellation or nonrenewal, again exposing the holder to undue risk stemming from an inadequately insured subcontractor or service provider. This in turn may lead to an increased premium cost for the holder. For example, if a subcontractor fails to carry worker's compensation coverage and an employee is injured, most state laws require that the general contractor's policy pay for the worker's injury, rehabilitation and lost income. The increased claims activity on the general contractor's policy causes the general contractor's experience modification to increase, directly increasing his premium in future years.

Additionally, there are two significant issues for insurance companies. First is the logistical problem of receiving, checking and storing millions of COIs from their agents, and second is the problem of having an agent issue an unauthorized COI. Many Insurers tell their agents not to send them COI copies, and others receive and store COIs without checking for accuracy. Some dishonest agents will alter or falsify certificates when there is no insurance in force behind the COI.

Accordingly, there is a need for a simple and effective method of securely and quickly getting insurance information from an agent to a holder. There is also a need for enabling holders to efficiently receive, evaluate and track insurance information. There is another need for Insurers to prevent unauthorized COI issuance and to monitor COIs without handling excessive amounts of paper. There is a further need for a method permitting an agent to quickly and reliably notify a holder when an insured's policy is cancelled, expires, and when a cancelled policy is reinstated.

### SUMMARY OF THE INVENTION

Generally, the present invention provides a computer-implemented method for providing insurance information across a network. The invention provides for three classes of user: insurance agents, brokers, or companies who do not use agents (collectively referred to as “agents”); insurance companies who use agents to issue certificates of insurance on their behalf (referred to as “Insurers”); and those who receive certificates from agents, referred to as “certificate holders” (or simply “holders”).

If the user is an agent, he may enter new or updated insurance information for an insured. This insurance information is typically stored as a record in a database, along with the time and date of entry. Each new entry (or change to an existing entry) generates a unique record, which is individually stored. Should the agent enter policy information for a new insured not already recognized by the invention, a unique, randomly-generated access code and password is created for and assigned to that insured.

The insured may give this access code and password to a holder as a “key” or permission for the holder to view the information, who in turn may use them to access the insured's information. Holders may view insurance information for each insured for whom they have the proper access code and password. The holder may also enter a set of insurance requirements, and the invention will automatically compare the insured's insurance coverage to these requirements and display the information in four different formats. Alternate embodiments may employ more or fewer formats without departing from the spirit or scope of the invention.

The invention automatically generates and displays an “exception report,” showing all the insured's coverages that fail to comply with the holder's requirements. This report displays in the coverage condition, the requirement and the corresponding information posted by the agent. For example, it may show “each occurrence limit” in the left column, $1,000,000 as the requirement in the center, and $500,000 as the limit carried by the insured in the right column. If a coverage condition requirement is satisfied or exceeded by the information entered by the agent, that coverage condition is not displayed. If all requirements are satisfied, the coverage shows “coverage complies.” If the policy providing coverage is expired or cancelled, no conditions are evaluated or displayed, and the coverage section of the exception report displays “coverage expired” or “coverage cancelled.” If no agent entered data for a coverage, “no coverage entered” is displayed, and if the holder did not enter any requirement for a coverage, the invention displays “no requirements entered.”

The holder may also generate a “compliance report,” which summarizes the compliance status of each coverage for all insureds. In one embodiment, this information is presented in an alphabetically ordered table format. Sample compliance statuses include “OK” where a coverage meets or exceeds a holder's requirements, “LOW” if the coverage does not meet the requirements, “EXP” where a policy has expired, and “CNX” where a policy is cancelled. Alternative embodiments may use different terms, or more or fewer levels of compliance. The holder may also generate an expiration report, which shows the expiration dates for each of an insured's policies. This expiration report, by default, shows only those insureds who have a policy that has expired, been cancelled, or a policy that will expire within 30 days of the date the report is viewed. A button on the screen allows the holder to toggle to a full report of all insureds.

Finally, the holder may view the information on a unique certificate report from the database, displaying all the data inputted by all agents, but limited to what is required by the holder. The signature of the agent who entered the information is displayed in each coverage section, along with the coverage conditions, policy numbers and dates, and policy limits.

### BRIEF DESCRIPTION OF THE DRAWINGS

FIG. 1 displays an exemplary operating environment for an embodiment of the present invention.

FIG. 2 is a flowchart detailing paths between major web pages in accordance with an exemplary embodiment of the present invention.

FIG. 3 displays a screenshot of a web page in accordance with an exemplary embodiment of the present invention.

FIG. 4 displays a screenshot of a web page in accordance with an exemplary embodiment of the present invention.

FIG. 4A displays a screenshot of a web page in accordance with an exemplary embodiment of the present invention.

FIG. 4B displays a screenshot of a web page in accordance with an exemplary embodiment of the present invention.

FIG. 4C displays a screenshot of a web page in accordance with an exemplary embodiment of the present invention.

FIG. 4D displays a screenshot of a web page in accordance with an exemplary embodiment of the present invention.

FIG. 4E displays a screenshot of a web page in accordance with an exemplary embodiment of the present invention.

FIG. 4F displays a screenshot of a web page in accordance with an exemplary embodiment of the present invention.

FIG. 5 displays a screenshot of a web page in accordance with an exemplary embodiment of the present invention.

FIG. 5A displays a screenshot of a web page in accordance with an exemplary embodiment of the present invention.

FIG. 6 displays a screenshot of a web page in accordance with an exemplary embodiment of the present invention.

FIG. 6A displays a screenshot of a web page in accordance with an exemplary embodiment of the present invention.

FIG. 6B displays a screenshot of a web page in accordance with an exemplary embodiment of the present invention.

FIG. 6C displays a screenshot of a web page in accordance with an exemplary embodiment of the present invention.

FIG. 7 displays a screenshot of a web page in accordance with an exemplary embodiment of the present invention.

FIG. 7A displays a screenshot of a web page in accordance with an exemplary embodiment of the present invention.

FIG. 7B displays a screenshot of a web page in accordance with an exemplary embodiment of the present invention.

FIG. 7C displays a screenshot of a web page in accordance with an exemplary embodiment of the present invention.

FIG. 7D displays a screenshot of a web page in accordance with an exemplary embodiment of the present invention.

FIG. 7E displays a screenshot of a web page in accordance with an exemplary embodiment of the present invention.

FIG. 8 displays a screenshot of a web page in accordance with an exemplary embodiment of the present invention.

FIG. 8A displays a screenshot of a web page in accordance with an exemplary embodiment of the present invention.

FIG. 8B displays a screenshot of a web page in accordance with an exemplary embodiment of the present invention.

FIG. 9 displays a screenshot of a web page in accordance with an exemplary embodiment of the present invention.

FIG. 10 displays a screenshot of a web page in accordance with an exemplary embodiment of the present invention.

FIG. 11 displays a screenshot of a web page in accordance with an exemplary embodiment of the present invention.

FIG. 12 displays a screenshot of a web page in accordance with an exemplary embodiment of the present invention.

FIG. 13 displays a screenshot of a web page in accordance with an exemplary embodiment of the present invention.

FIG. 14 displays a screenshot of a web page in accordance with an exemplary embodiment of the present invention.

FIG. 15 displays a screenshot of a web page in accordance with an exemplary embodiment of the present invention.

FIG. 16 displays a screenshot of a web page in accordance with an exemplary embodiment of the present invention.

FIG. 17 displays a screenshot of a web page in accordance with an exemplary embodiment of the present invention.

FIG. 18 displays a screenshot of a web page in accordance with an exemplary embodiment of the present invention.

FIG. 19 displays a screenshot of a web page in accordance with an exemplary embodiment of the present invention.

FIG. 20 displays a screenshot of a web page in accordance with an exemplary embodiment of the present invention.

FIG. 20A displays a screenshot of a web page in accordance with an exemplary embodiment of the present invention.

FIG. 21 displays a screenshot of a web page in accordance with an exemplary embodiment of the present invention.

FIG. 22 displays a screen shot of a web page in accordance with an exemplary embodiment of the present invention.

FIG. 23 displays a screenshot of a web page in accordance with an exemplary embodiment of the present invention.

FIG. 24 displays a screenshot of a web page in accordance with an exemplary embodiment of the present invention.

FIG. 25 displays a screenshot of a web page in accordance with an exemplary embodiment of the present invention.

FIG. 26 displays a screenshot of a web page in accordance with an exemplary embodiment of the present invention.

FIG. 27 displays a screenshot of a web page in accordance with an exemplary embodiment of the present invention.

FIG. 28 displays a screenshot of a web page in accordance with an exemplary embodiment of the present invention.

FIG. 29 displays a screenshot of a web page in accordance with an exemplary embodiment of the present invention.

FIG. 30 displays a screenshot of a web page in accordance with an exemplary embodiment of the present invention.

FIG. 31 displays a screenshot of a web page in accordance with an exemplary embodiment of the present invention.

FIG. 32 displays a screenshot of a web page in accordance with an exemplary embodiment of the present invention.

FIG. 33 displays a screenshot of a web page in accordance with an exemplary embodiment of the present invention.

FIG. 34 displays a screenshot of a web page in accordance with an exemplary embodiment of the present invention.

FIG. 35 displays a screenshot of a web page in accordance with an exemplary embodiment of the present invention.

FIG. 36 displays a screenshot of a web page in accordance with an exemplary embodiment of the present invention.

FIG. 37 displays a screenshot of a web page in accordance with an exemplary embodiment of the present invention.

FIG. 38 displays a screenshot of a web page in accordance with an exemplary embodiment of the present invention.

FIG. 39 displays a screenshot of a web page in accordance with an exemplary embodiment of the present invention.

FIG. 40 displays a screenshot of a web page in accordance with an exemplary embodiment of the present invention.

FIG. 41 displays a screenshot of a web page in accordance with an exemplary embodiment of the present invention.

FIG. 42 displays a screenshot of a web page in accordance with an exemplary embodiment of the present invention.

FIG. 43 displays a screenshot of a web page in accordance with an exemplary embodiment of the present invention.

FIG. 44 displays a screenshot of a web page in accordance with an exemplary embodiment of the present invention.

FIG. 45 displays a screenshot of a web page in accordance with an exemplary embodiment of the present invention.

FIG. 46 displays a screenshot of a web page in accordance with an exemplary embodiment of the present invention.

FIG. 47 displays a screenshot of a web page in accordance with an exemplary embodiment of the present invention.

FIG. 48 displays a screenshot of a web page in accordance with an exemplary embodiment of the present invention.

FIG. 49 displays a screenshot of a web page in accordance with an exemplary embodiment of the present invention.

FIG. 50 displays a screenshot of a web page in accordance with an exemplary embodiment of the present invention.

FIG. 51 displays a screenshot of a web page in accordance with an exemplary embodiment of the present invention.

FIG. 52 displays a screenshot of a web page in accordance with an exemplary embodiment of the present invention.

FIG. 53 displays a screenshot of a web page in accordance with an exemplary embodiment of the present invention.

FIG. 53A displays a screenshot of a web page in accordance with an exemplary embodiment of the present invention.

FIG. 54 displays a screenshot of a web page in accordance with an exemplary embodiment of the present invention.

FIG. 55 displays a screenshot of a web page in accordance with an exemplary embodiment of the present invention.

FIG. 56 displays a screenshot of a web page in accordance with an exemplary embodiment of the present invention.

FIG. 57 displays a screenshot of a web page in accordance with an exemplary embodiment of the present invention.

FIG. 58 displays a screenshot of a web page in accordance with an exemplary embodiment of the present invention.

FIG. 59 displays a screenshot of a web page in accordance with an exemplary embodiment of the present invention.

### DETAILED DESCRIPTION

Generally described, the present invention provides a method and system for creating, tracking, evaluating, reporting, and viewing insurance information across a network. More specifically, the present invention enables the online posting and review of insurance coverage for an insured party (the “insured”) in multiple formats.

The present invention may accept multiple types of insurance information. Typically, this insurance information details the coverage afforded by an insurance company to the insured, including general liability, automobile, professional liability, pollution liability, umbrella (or “excess”) liability, workers' compensation, property, and marine insurance, although other types of insurance may be tracked and reported by the invention. Further, the invention may accept custom insurance data of a type determined by the agent, who inputs the data.

In one embodiment of the present invention, there are three classes of users: Insurers, agents, and holders. Alternate embodiments may have more or fewer user classes. For example, the insurance agency and agent classes may be combined in one embodiment, while the insured may be a fourth user class in another embodiment. Each user is given a unique user name and password, in order to easily and efficiently differentiate one user from another. Each user class has different functions and options available while using an embodiment of the invention, as discussed in detail below.

Insurers may view any COI where they are shown as the Insurer for at least one coverage, but they may not view any coverage where they are not the designated Insurer. Insurers may also block agents no longer associated with a given Insurer from entering fraudulent insurance information.

Agents may enter insurance policy information for an insured into a database accessed across a network. When information about an insured is first entered, a unique and permanent “Access Code” and “Password” combination is generated for that insured. Subsequent entries for the same insured are tied to the same access code. Typically, an agent forwards the code to the insured so that the insured may pass the code along to a holder, as discussed below.

Agents may further change insurance policy information at any time. The date and time of each entry and the effective date of all data changes are noted by the invention and stored along with the insurance data as a record in a database. Each change is separately stored, and does not overwrite or otherwise affect existing records. For example, if an agent initially enters a $1,000,000 property insurance policy for an insured on May 5, 2001, at 3:15 p.m., the invention stores the date and time of entry along with the type of coverage and policy limits as a database record linked to the insured. Should the agent later change the property insurance policy to reflect an increase in coverage, the new coverage amount, date, and time of the change are stored as a second record.

The third user type is a certificate holder. Generally speaking, a certificate holder is one who requires that an insured have adequate insurance coverage in connection with a business relation or transaction. For example, a general contractor may require that all subcontractors involved in building a house have a certain amount of general liability insurance covering their work. Traditionally, a subcontractor, such as a plumber, would demonstrate compliance with the general contractor's requirements through a paper certificate of insurance, showing the plumber's insurance coverages in various categories. In this example, the general contractor is the certificate holder, while the plumber is the insured.

With respect to one embodiment of the present invention, an insured gives his code to the holder in order to allow the holder access to the insured's stored insurance information. When the holder inputs the code, the embodiment recognizes that the current user is a holder and presents a different set of options than that given to an agent. Holders may view an insured's various policies and insurance limits, as well as generate exception and compliance reports. The holder inputs minimum insurance requirements, which the invention compares to the insured's coverage data, as of the effective date selected by the holder. Multiple sets of criteria may be specified and stored for the holder. For example, a holder may require an insured have $500,000 of professional liability insurance, and $1,000,000 of general liability insurance. Each coverage requirement is entered from a different screen and may utilize a variety of input forms, such as pull-down menus, radio buttons, input boxes, and so forth.

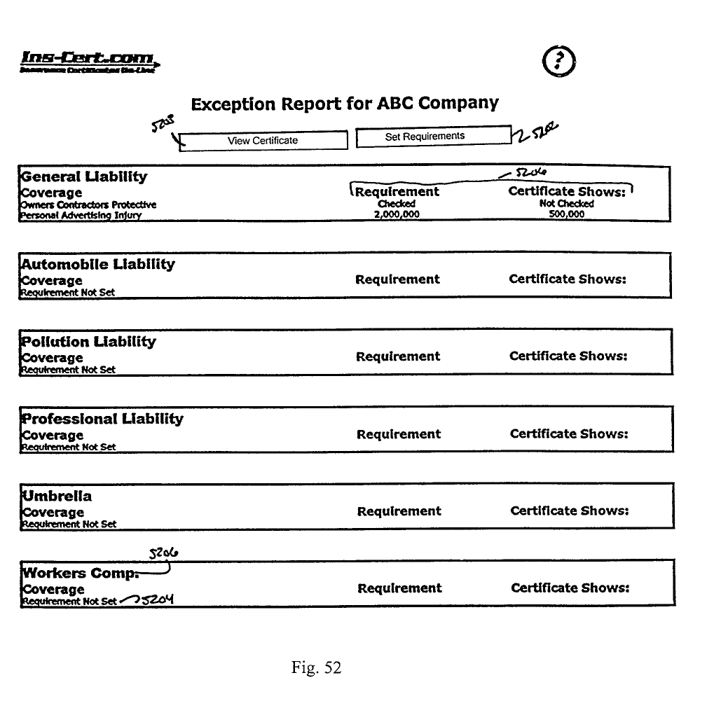

Once the holder specifies his insurance requirements, the invention compares each requirement to the insured's corresponding coverage, as of the effective date selected by the holder. Generally, the invention determines whether the insured's coverage meets the criteria, is below the criteria, is expired, or has been cancelled. These results are then combined and displayed, with each insurance coverage as a separate section of the exception report. The exception report typically indicates which of the insured's coverages do not comply with the holder's requirements, displays both the requirement and the corresponding coverage entered by the insured's agent, and shows if the coverage has been cancelled or is expired. A sample exception report is shown in FIG. 52. Alternative embodiments may format an exception report differently, or may display more or less data than given above.

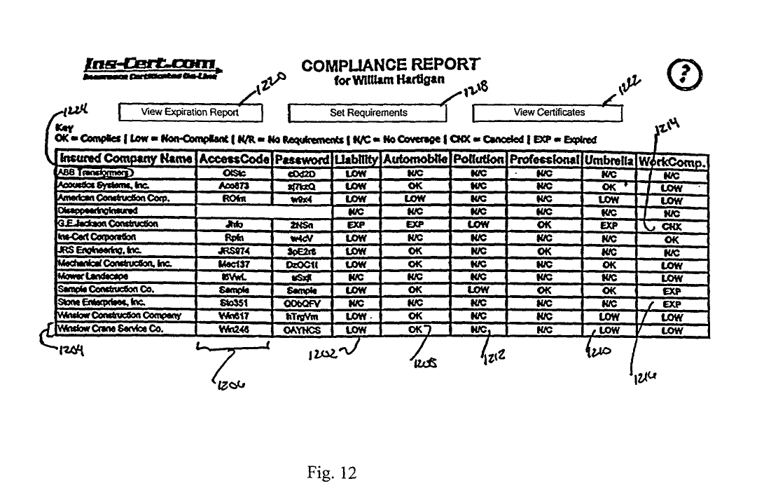

The embodiment may also display these results in another format called a “compliance report.” The compliance report is a table of all insureds viewed by the holder and is shown in FIG. 12. The compliance report, lists all insureds in alphabetical order, with each one's access code and password, followed by each insured's data on one row, while each of the six insurance coverages is a column. The compliance report displays each insured's coverage compliance status in a separate cell formed by the intersection of the insured row and insurance type column. For example, in FIG. 12, Acoustics Systems, Inc. has “LOW” general liability and “OK” automobile insurance. The embodiment typically displays “OK” in a cell if an insured's coverage meets or exceeds the holder's requirement for all aspects of that coverage, “LOW” if any aspect of the insured's policy fails to comply with the holder's requirements, “N/R” if no holder requirement was set, “N/C” if no coverage was entered, “CNX” if the insured's policy is cancelled, and “EXP” if the policy has expired. Alternative embodiments may use different abbreviations or may include additional insurance states. For example, an alternative embodiment may display an expiration or cancellation date instead of “EXP” and “CNX,” or may use color coding in place of dates or abbreviations.

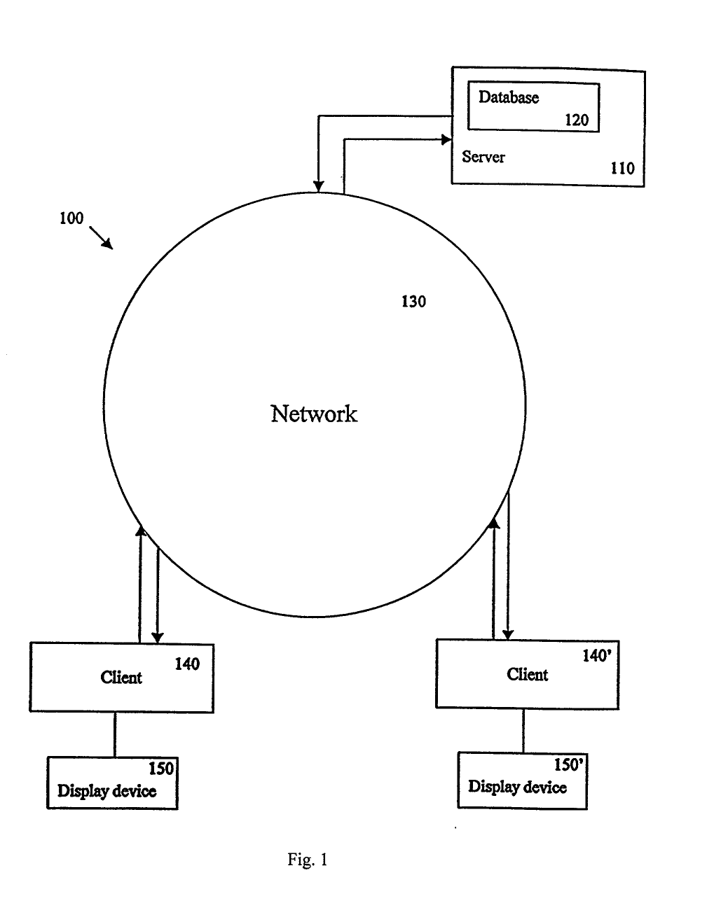

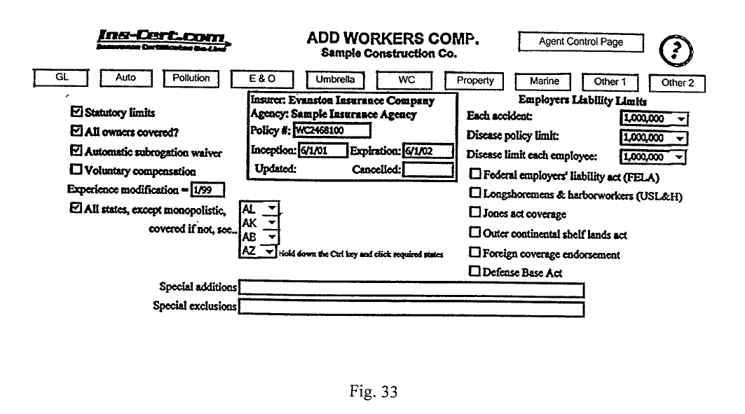

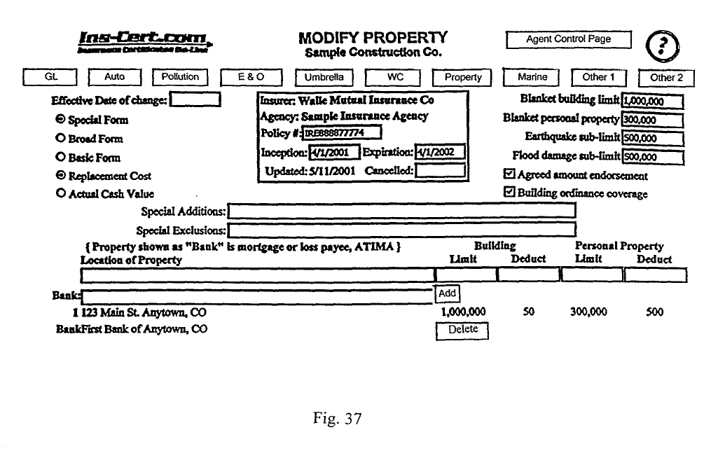

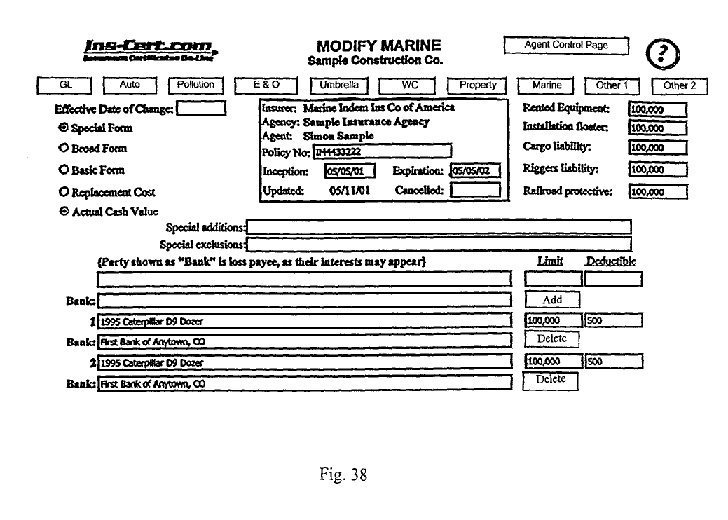

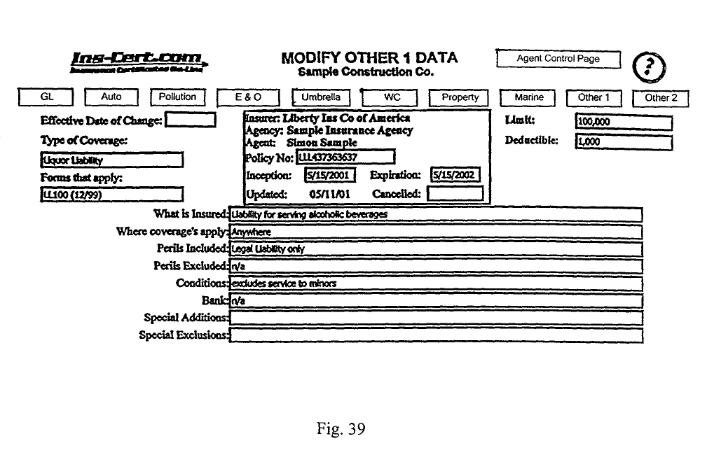

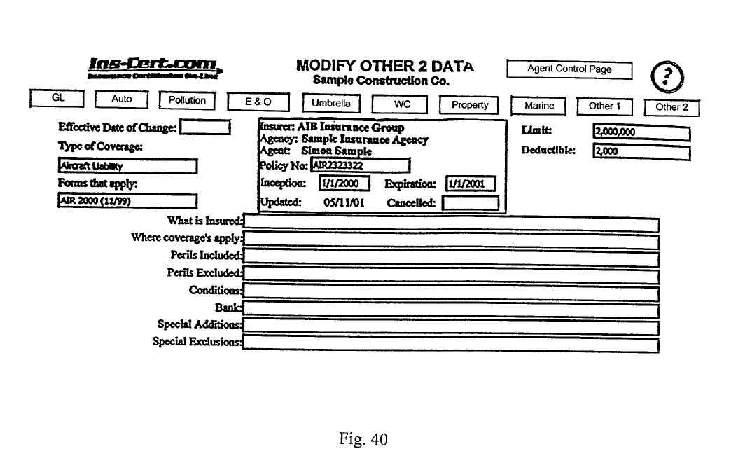

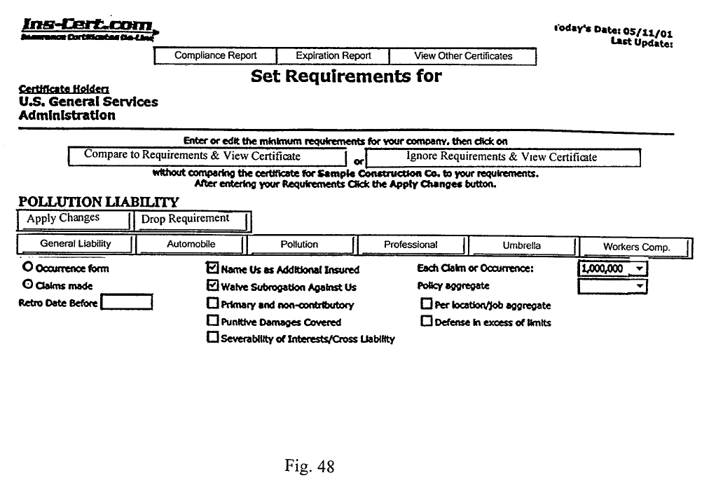

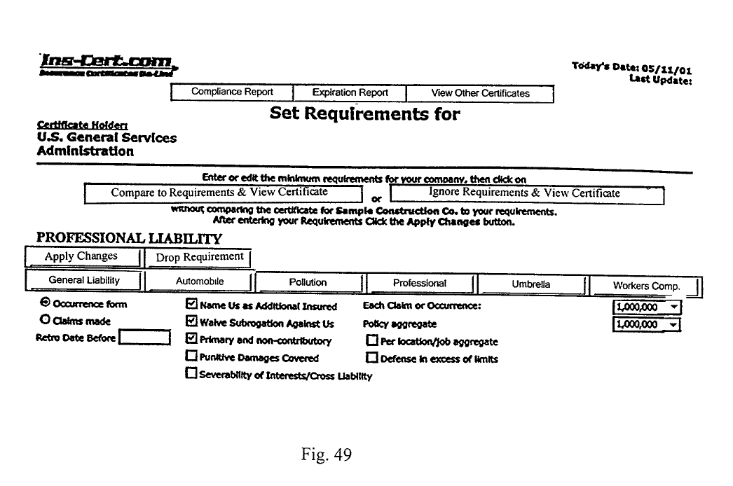

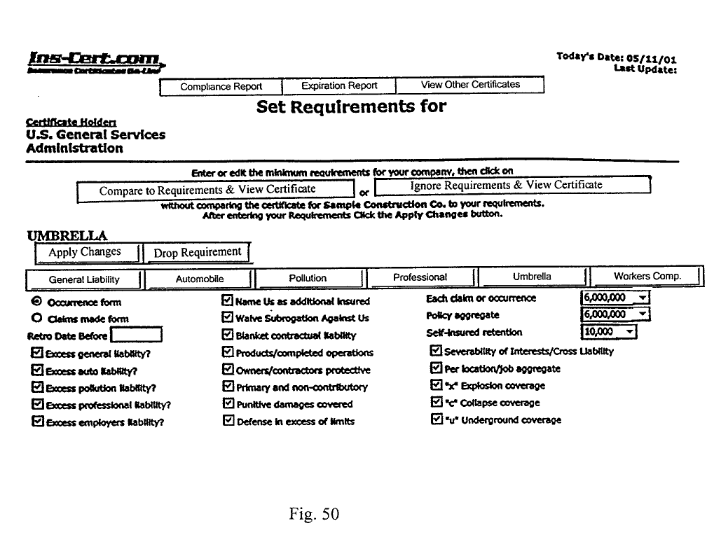

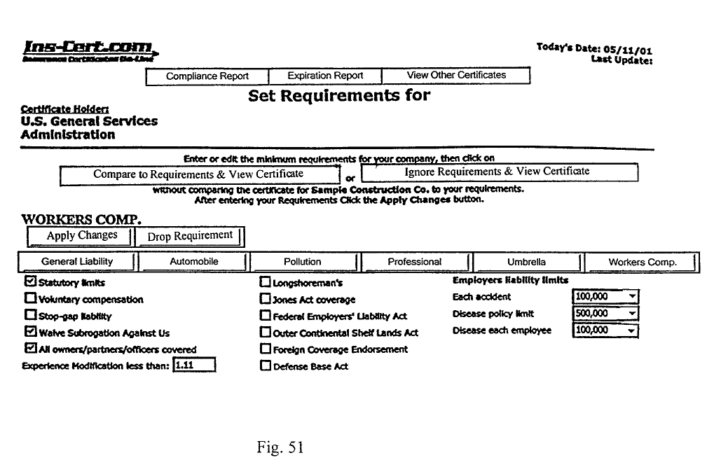

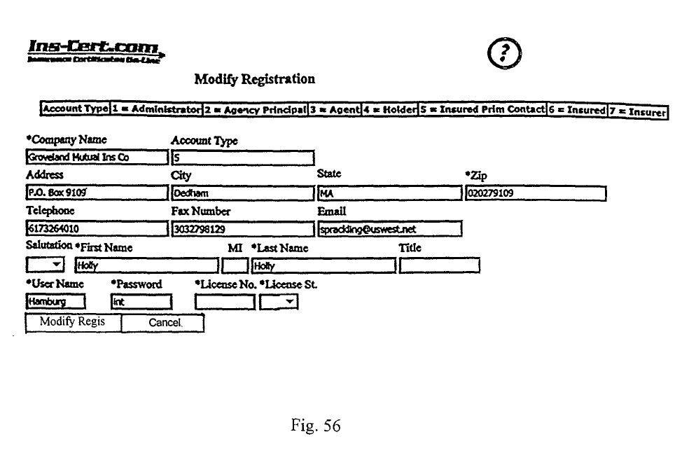

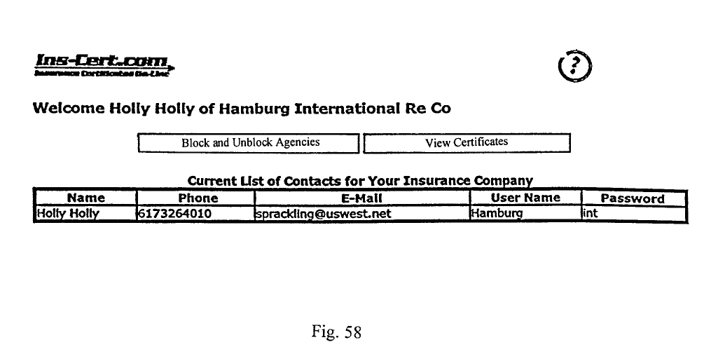

An operating environment and details of the operation of an embodiment of the present invention are discussed in more detail below with reference to FIGS. 1-59.

Operating Environment

FIG. 1 shows a suitable operating environment for an embodiment of the present invention. A system 100 operates over a network 130. The system generally consists of a database 120 stored on a server 110 and at least one client 140. The server 110 and client 140 are typically microprocessor-based computers, although any form of computing device may function as either a server or client. Acceptable servers and/or clients include RISC processor-based computers, distributed computing environments, personal digital assistants, wireless devices, web tablets, mainframe systems, and so forth.

The database 120 stores insurance information pertaining to an insured as input by an agent. In one embodiment, the database 120 is a lookup table indexed by unique identifiers associated with an insured on a one-to-one basis. In other words, each insured has only one database record identifier, apart from name or any other data, any of which may be changed. Alternative embodiments may employ different types of databases, or may index records in the database differently. For example, an alternative embodiment may index database records by the insureds' or entering agents' names. In the present embodiment, the unique indexing identifier differs from either an insured's access code or password, and is used by the database solely to store, retrieve, and sort records.

Insurance information is typically entered into or retrieved from the database 120 through a client 140. A user may employ any conventional input means to enter an insurance record into the client, including a keyboard, mouse, microphone, light pen, trackball, touch pad, stylus, joystick, or other means well known to those skilled in the art. Once a record is entered, the client 140 transmits the data comprising the record to the server 110 across a network 130. Although the present embodiment makes use of the Internet, alternate embodiments may employ an intranet, local area network (LAN), wide are network (WAN), wireless transmission (including radio frequency and infrared signals), fiber optic line, a public switched telephone network (PSTN), or other land-line network. Accordingly, any reference to a “network” should be understood to embrace all of the foregoing and their equivalents.

The signal is received by the server 110 and stored in the database 120. In a similar manner, a user may employ the client 140 to retrieve a record across the network 130 from the database 120. Multiple clients 140, 140′ may access a single server 110.

Typically, the client 140 includes a display device 150 operable to display data retrieved from the database 120. Sample display devices include a computer monitor, television, liquid crystal display (LCD) screen, printer, and so forth. The display device 150 is not limited to a visual display, but may include a speaker for reproducing data stored as an audio signal.

The Embodiment

One embodiment of the present invention permits Internet posting of insurance certificate data by agents, brokers and insurers who do not use agents or brokers for certificate issuance, (collectively referred to as “agents”). Further, certificate holders (“holders”) and insurance companies (or “insurers”) gain network access to insurance certificate data, although certificate holder access is restricted by the requirement to enter a unique Access Code and Password for each insured the holder wishes to review.

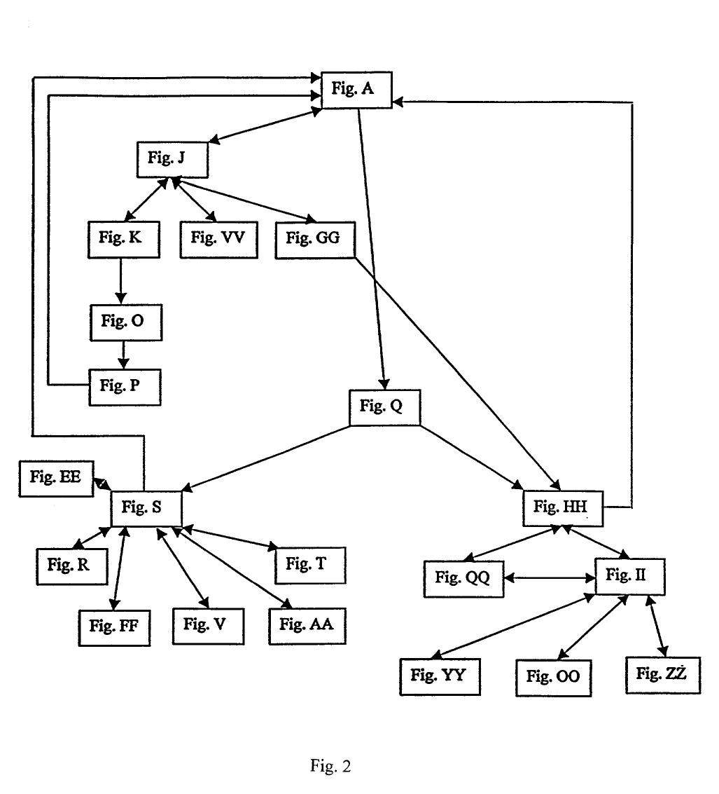

FIG. 2 displays a flowchart detailing the general paths between major web pages of an embodiment of the present invention. Each block (representing a web page) is labeled with the figure number on which the web page is displayed. Only a portion of the web pages displayed by the embodiment are shown in order to promote clarity. Alternative embodiments may include additional web pages, eliminate pages shown herein, or alter the paths between screens without departing from the spirit or scope of the invention.

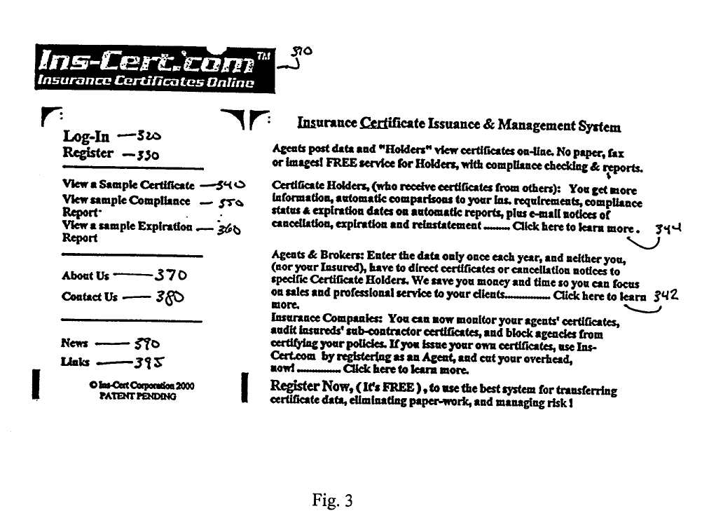

Turning now to FIG. 3, the home page of one embodiment of the present invention may be seen. The home page has links to detailed information, instructions and frequently asked questions (FAQ) customized for each type of user (agents, holders and Insurers). Throughout the system, a system logo 310 functions as a link to the home page.

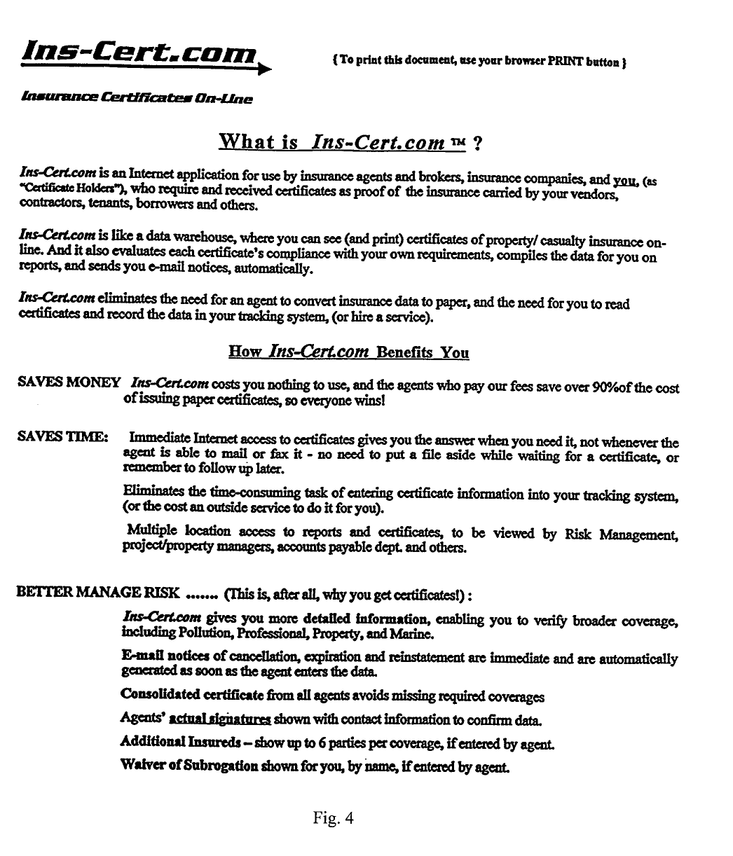

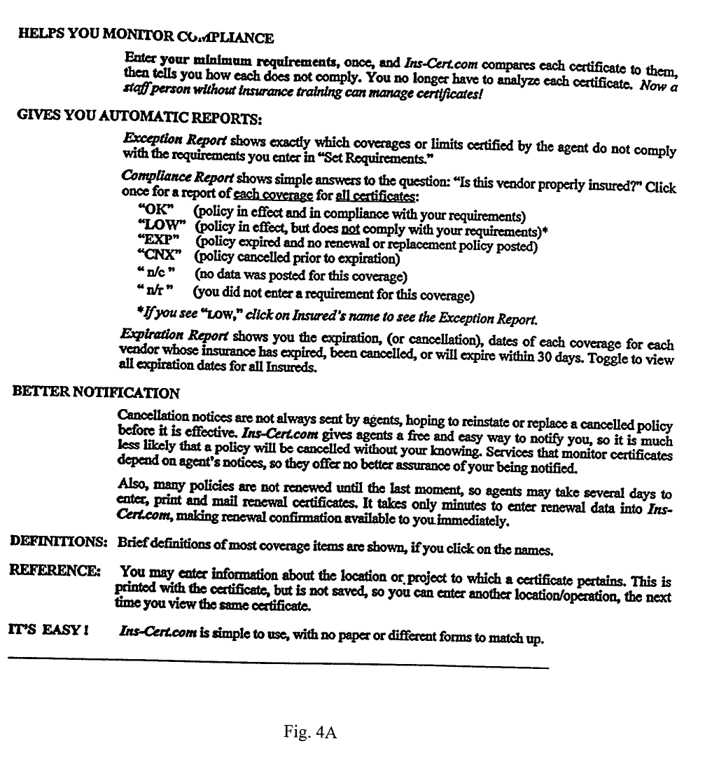

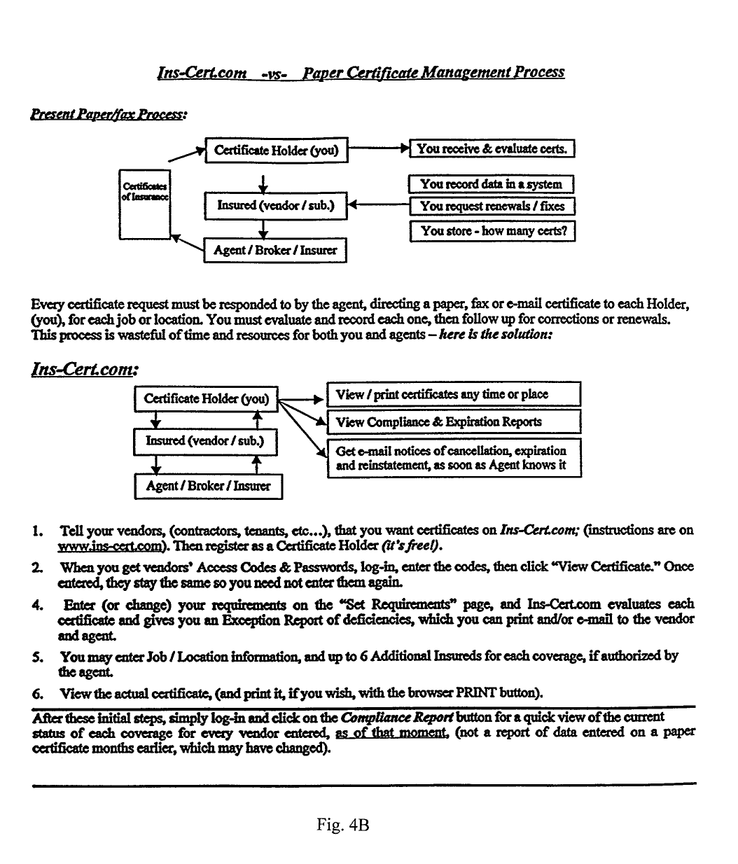

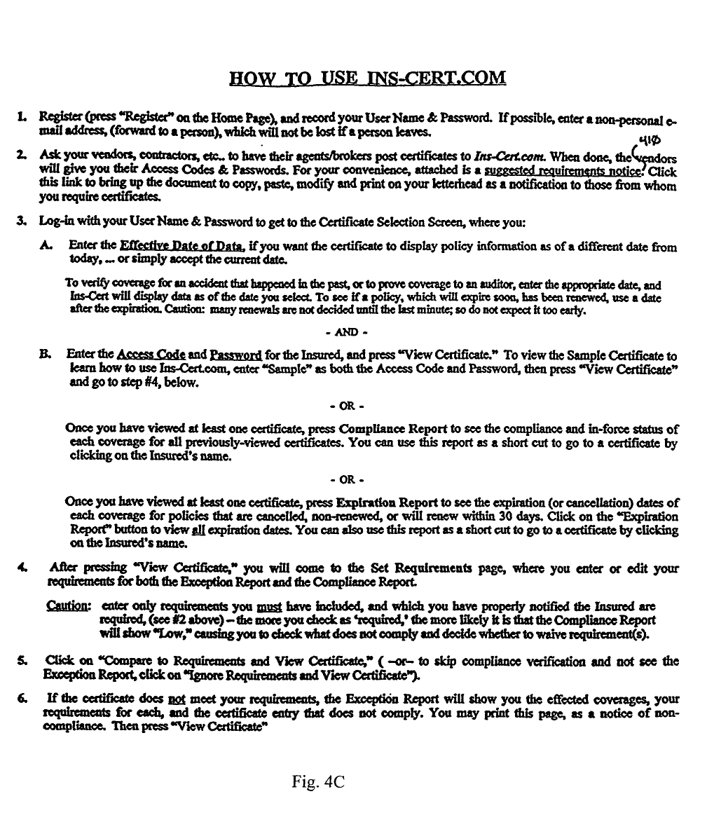

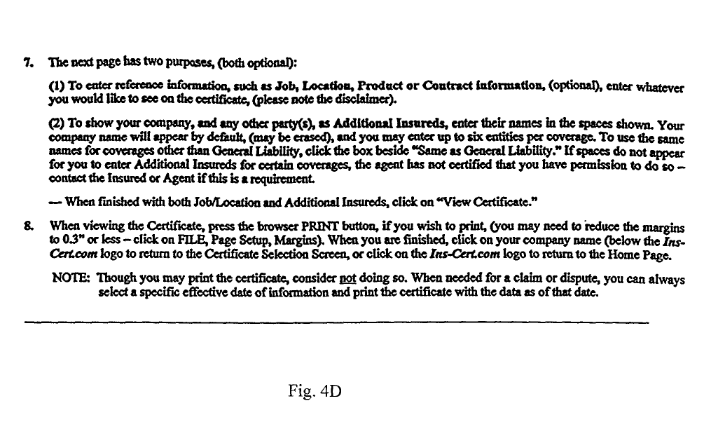

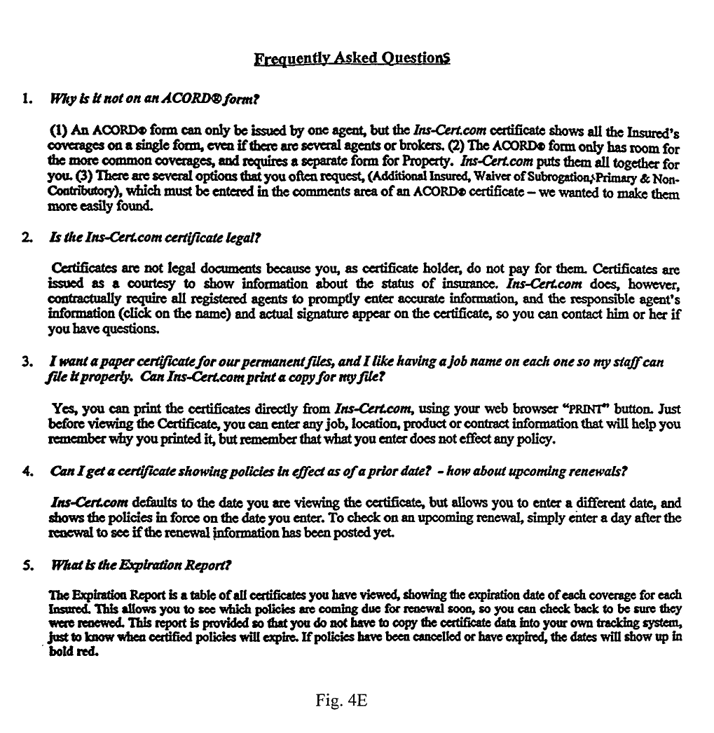

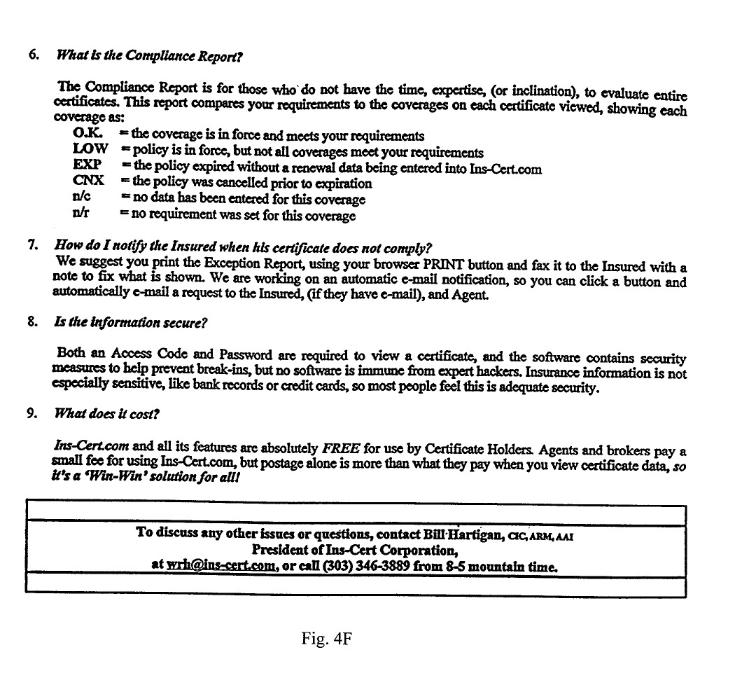

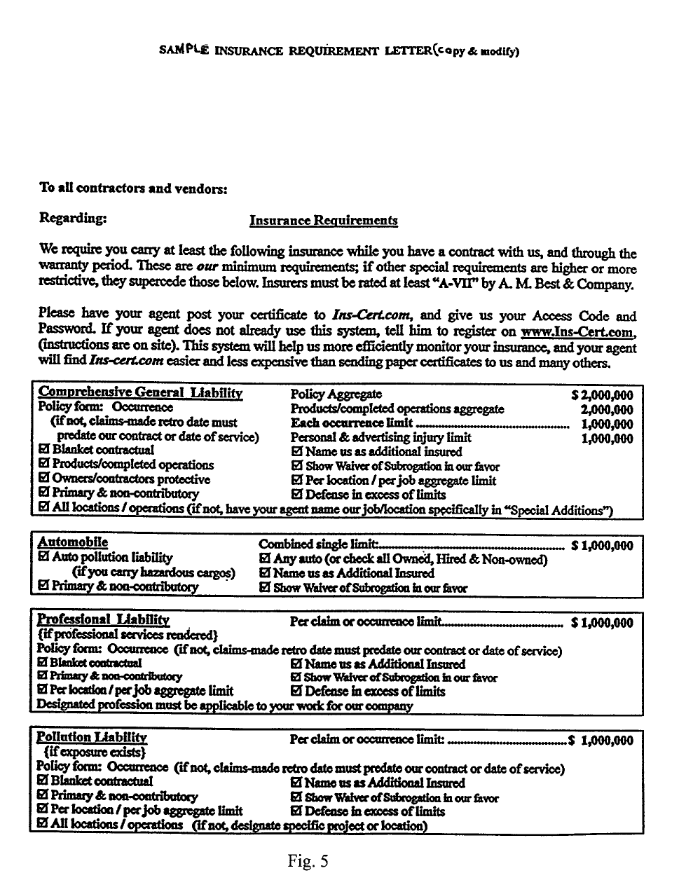

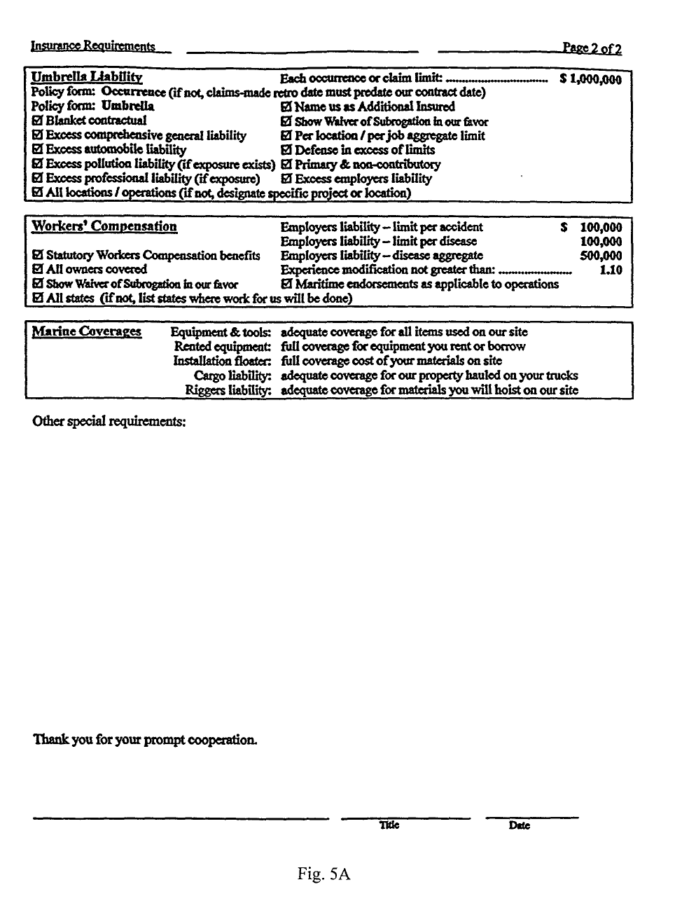

FIGS. 4-4F display an information, instruction and FAQ screen for holders. The screen also contains a link to a suggested notification letter 410, shown in FIG. 5. The notification letter may be used by holders to notify vendors, subcontractors, tenants, borrowers, and so on of the minimum insurance requirements imposed by the holder, as well as the requirement that the insureds require their agent(s) to use the invention rather than use paper COIs. Generally, a holder sends this type of letter to those parties with whom they have, or expect to have, a contract or business relationship.

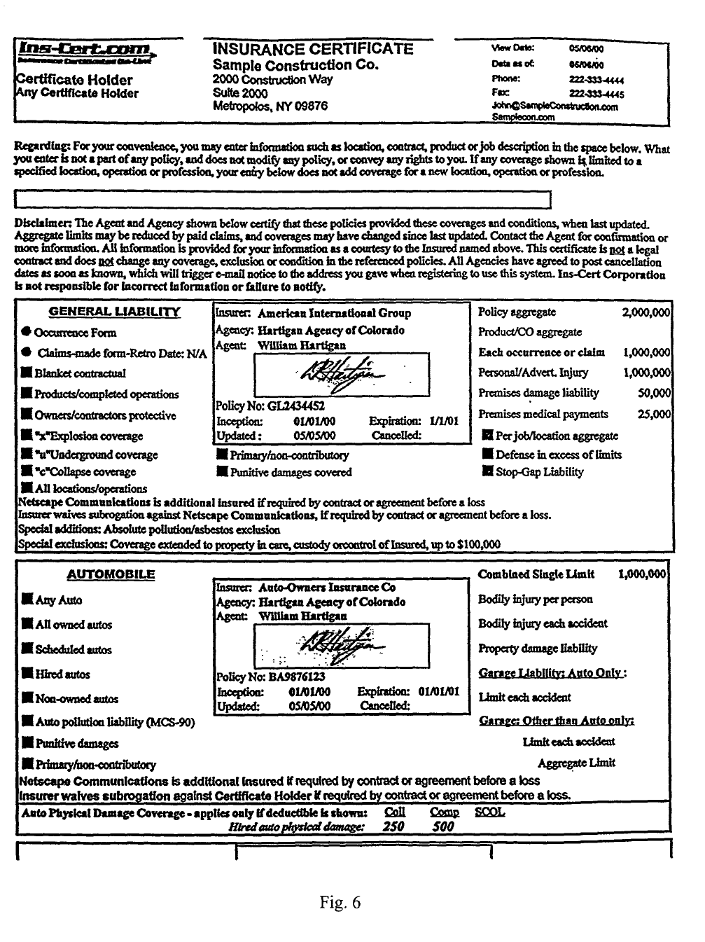

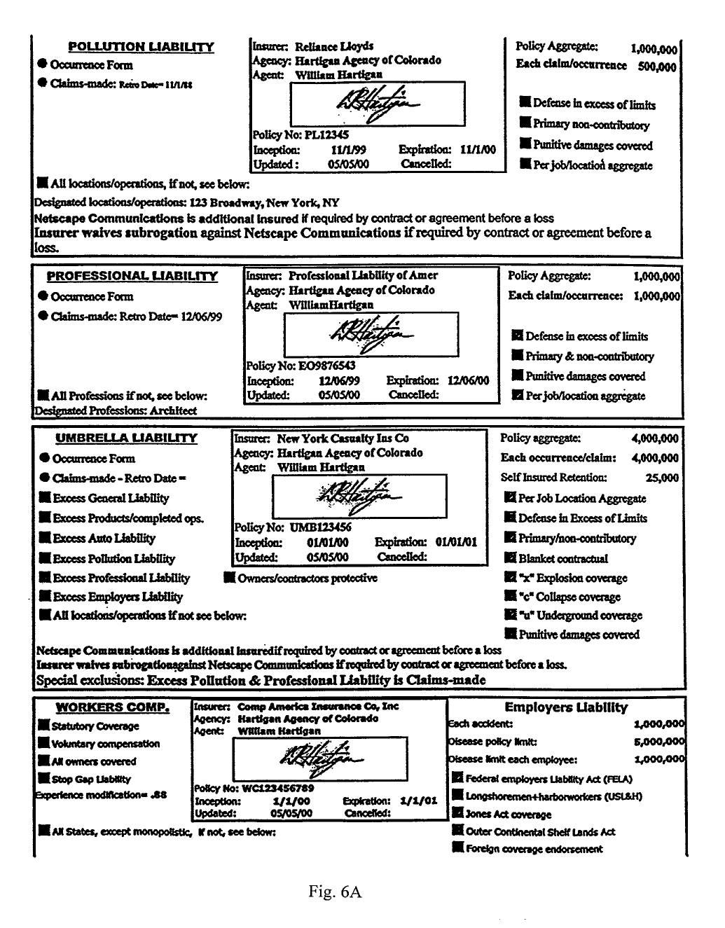

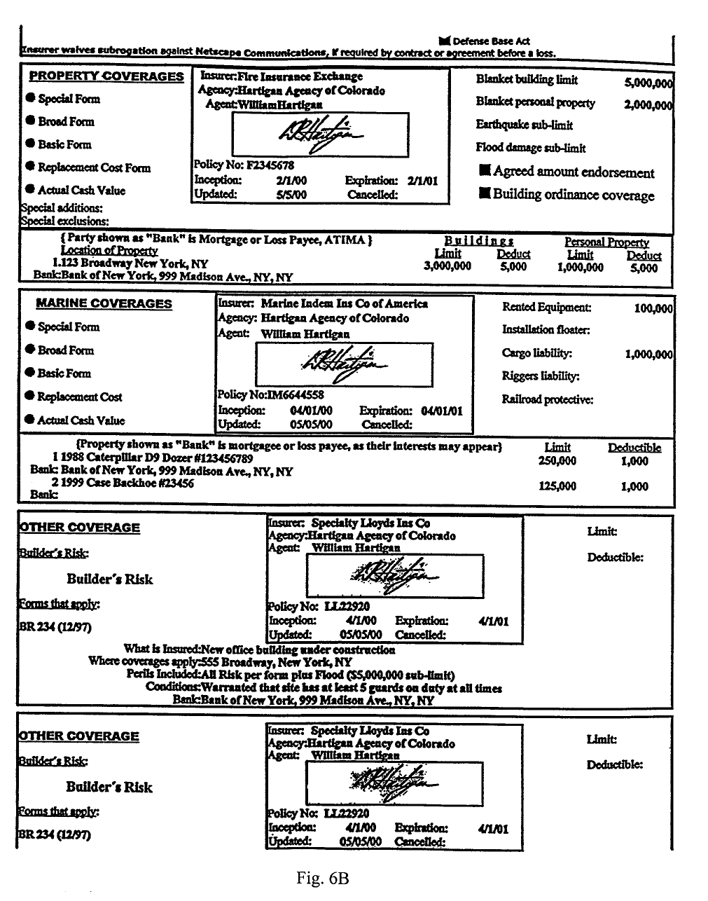

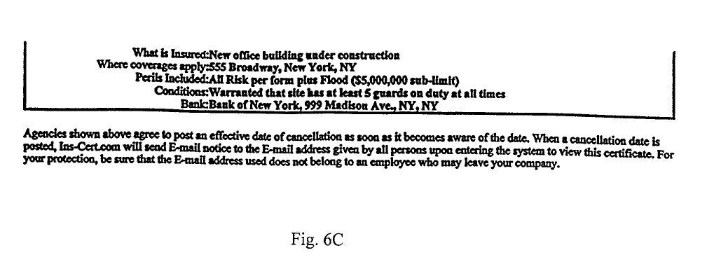

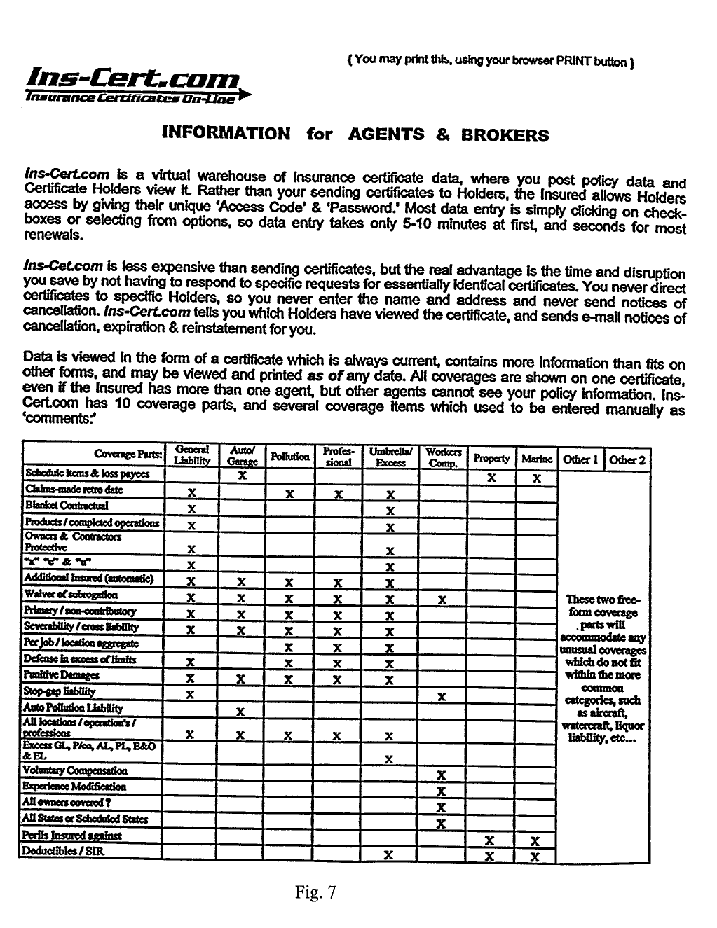

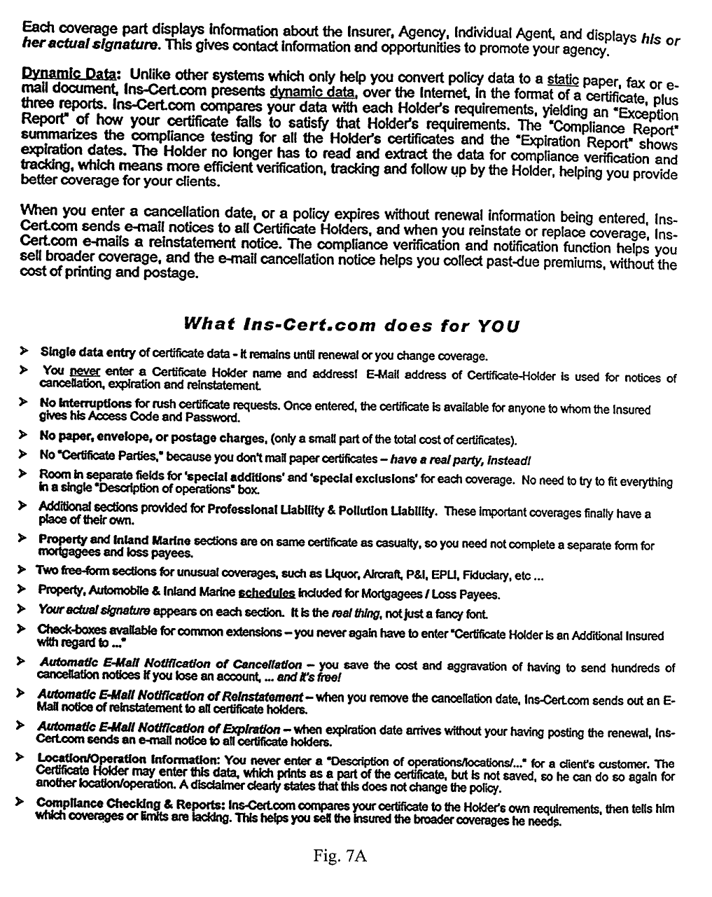

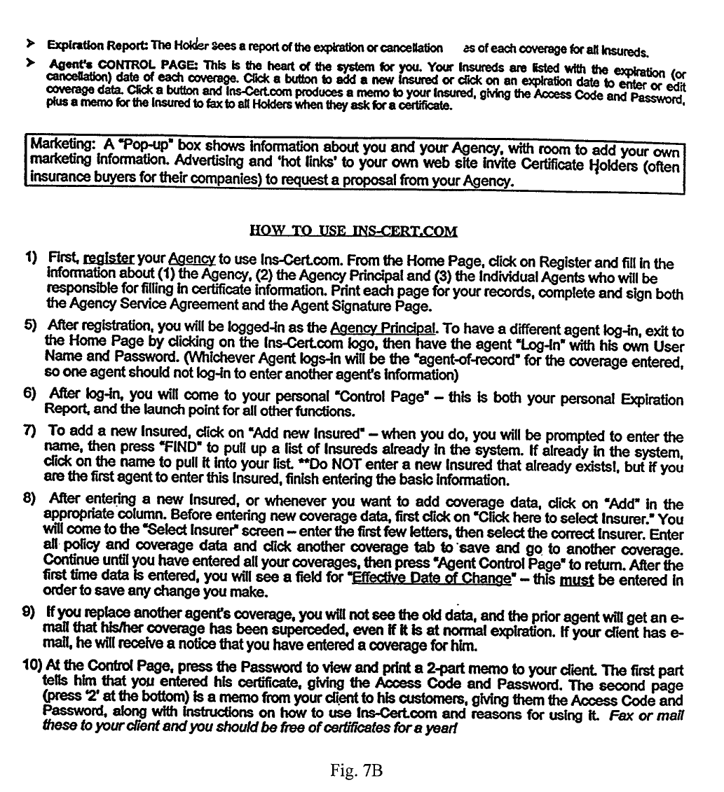

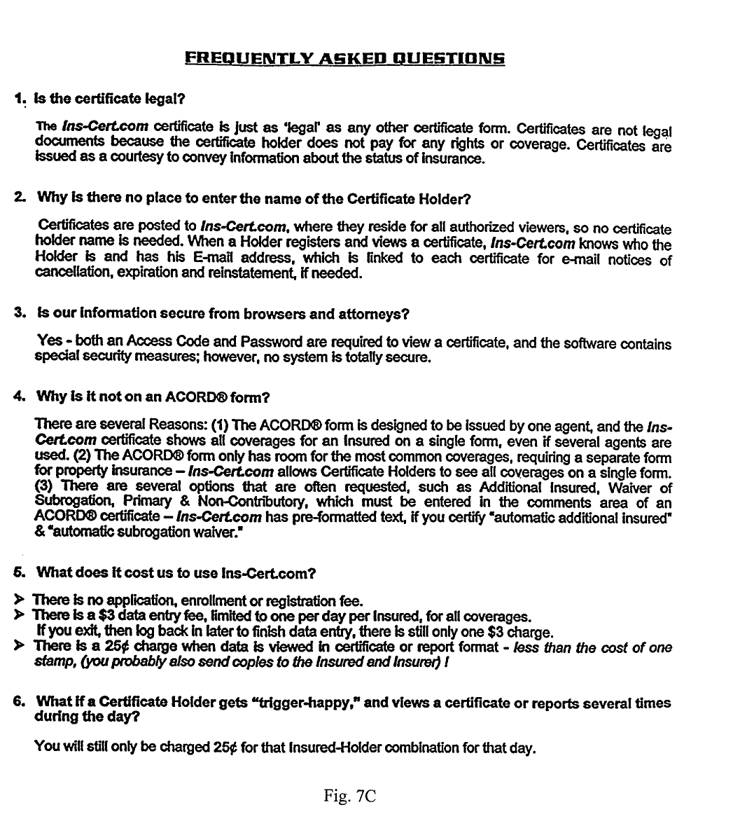

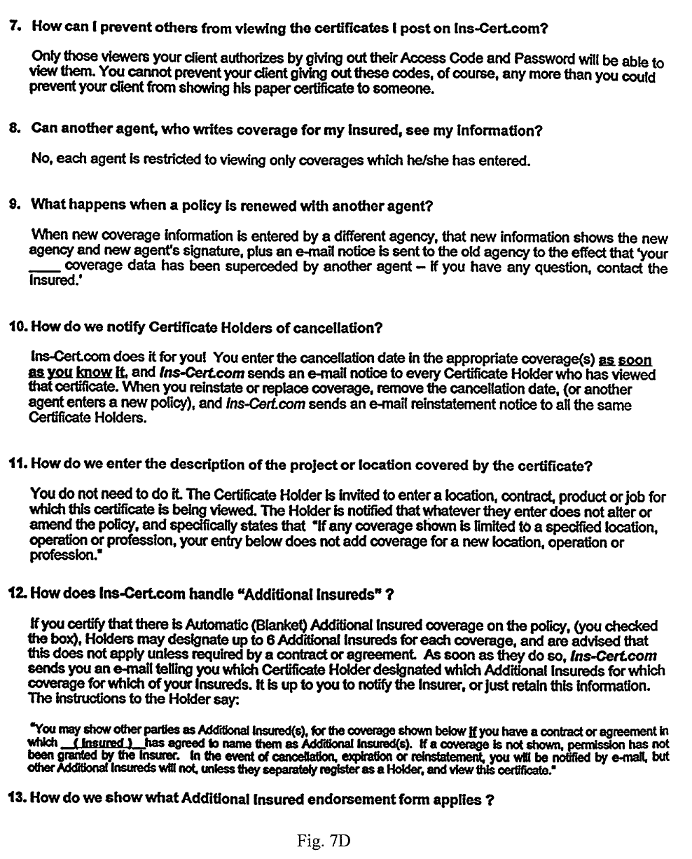

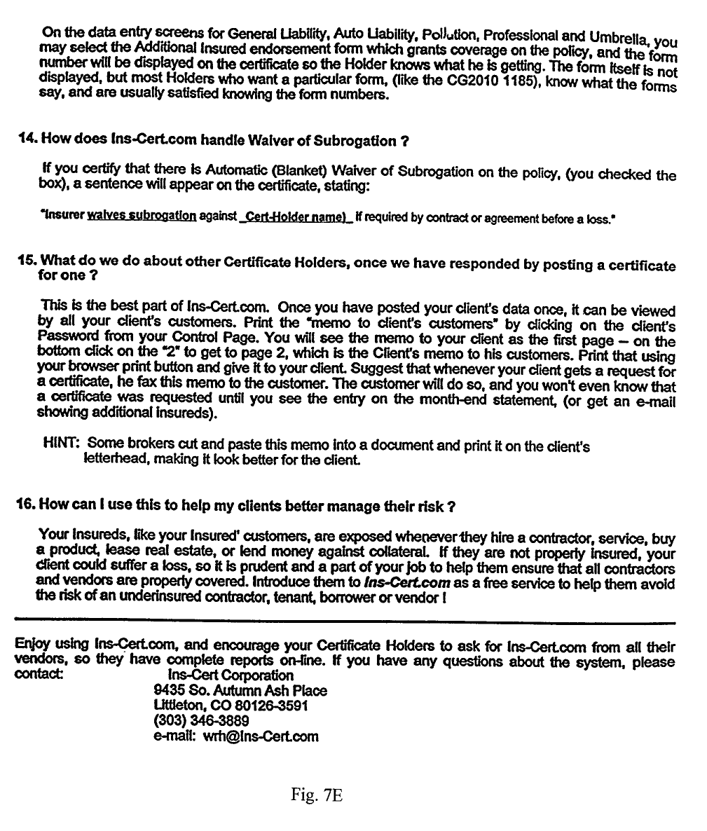

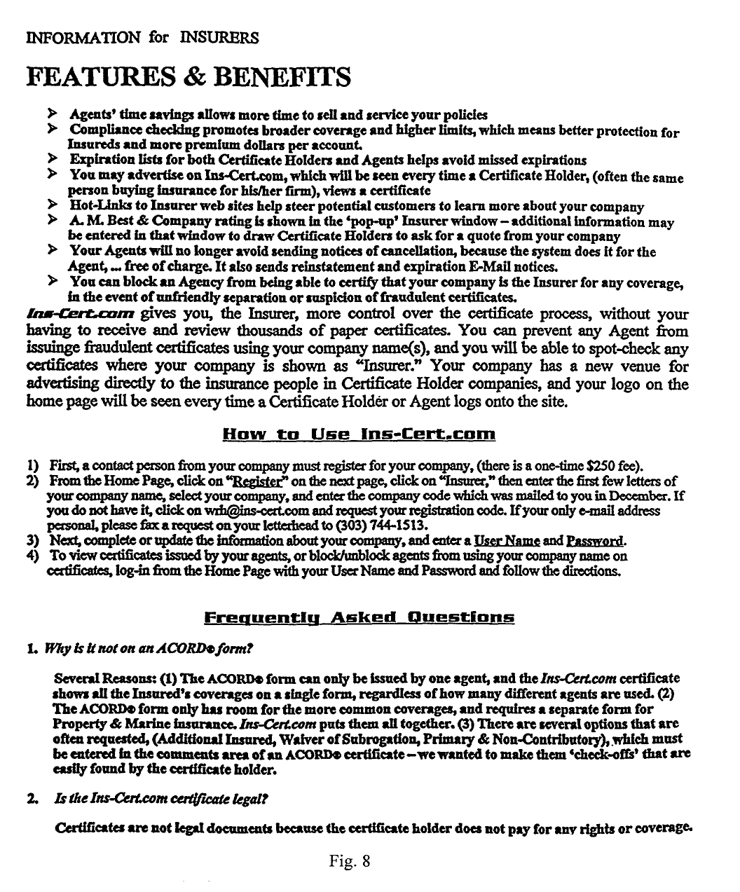

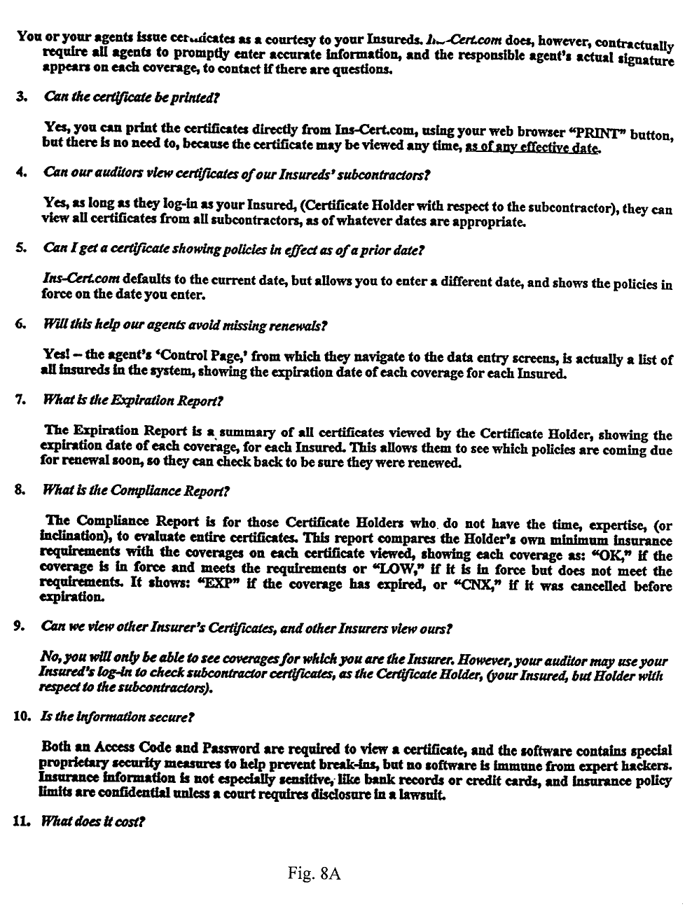

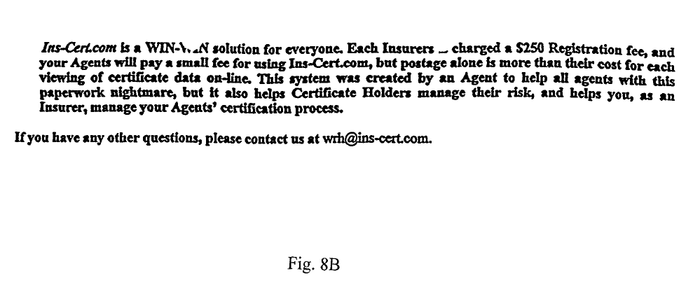

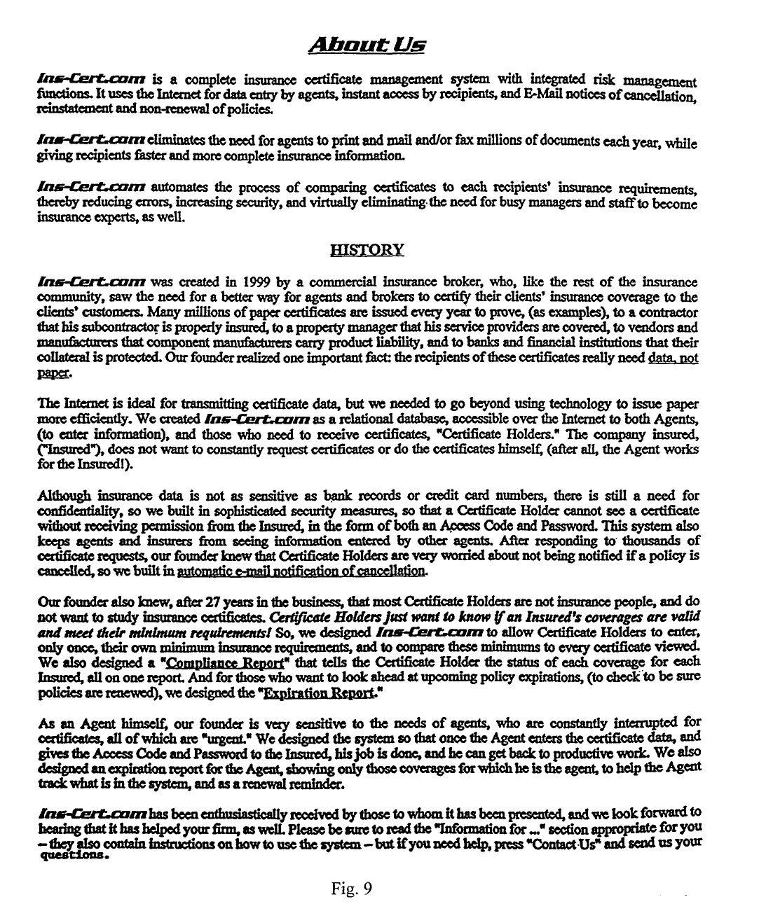

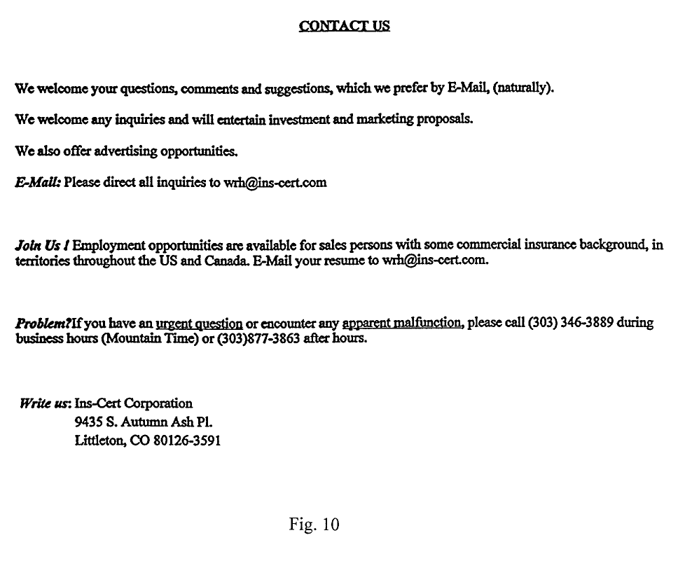

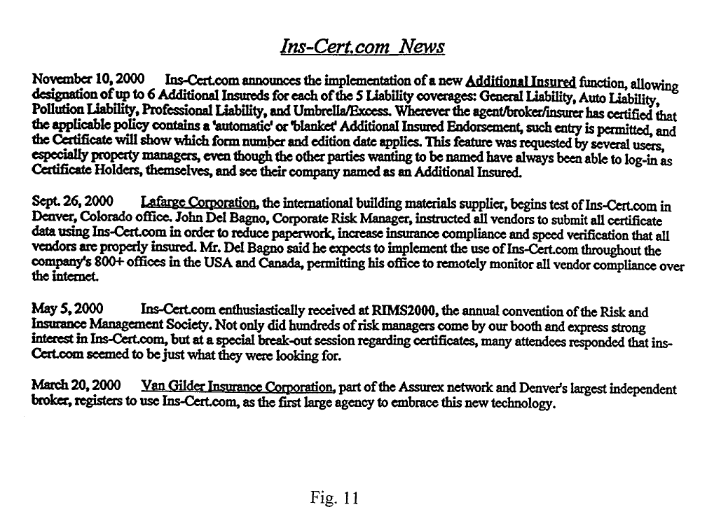

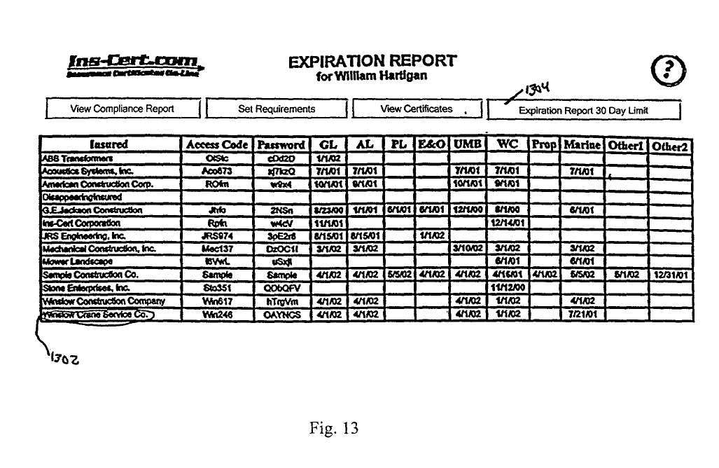

The home page shown in FIG. 3 also may contain a link 340 to a sample of the Certificate report (shown in FIG. 6), a link 342 to an “information, instructions and FAQs for agents” page (FIG. 7), a link 344 to an “information, instructions and FAQs for Insurers” page (FIG. 8), and a link 370 to a background page detailing information about the system administrator (FIG. 9). Additional links 380, 390 from the home page may lead to a contact information web page (FIG. 10) and a “News” page (FIG. 11). The home page may also contain a link 350 to a sample compliance report (FIG. 12), a link 360 to a sample expiration report (FIG. 13), and a link 395 to a “Links” page containing hyperlinks to related industry sites.

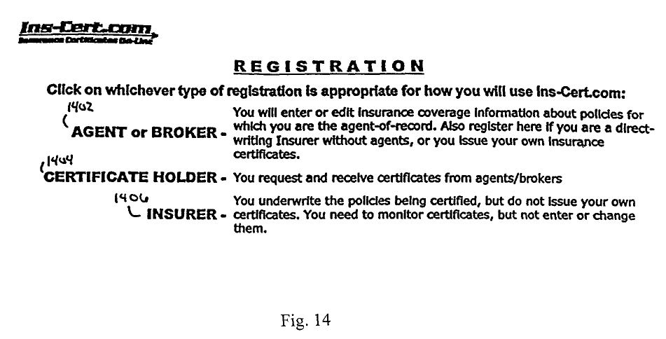

FIG. 14 displays the registration selection page, where a user may select which type of user he will register as with the system—agent/broker, holder, or Insurer by clicking the appropriate link 1402, 1404, 1406. agents are registered by the agency principal, who may register multiple agent-users within an organization (“agency”), each with his own user name and password, but typically only one principal per organization exists. The principal is the agent with authority over the agency and with authority to sign an agency service agreement. An agency with multiple locations may have each branch manager register as a “principal” of the branch office as if it were a separate entity, in order to simplify operations. Alternative embodiments may allow additional principals for a single organization.

Agency Registration

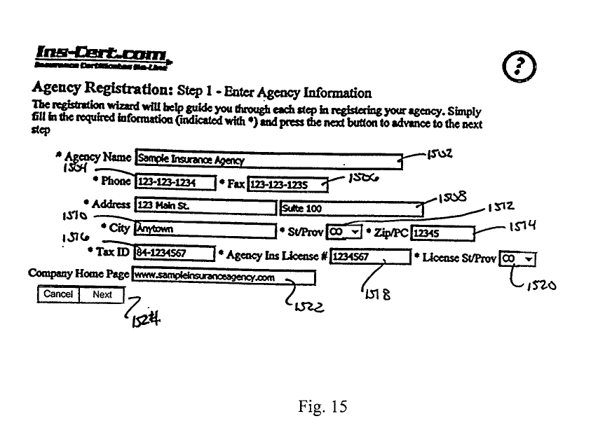

If the user selects the “agent or Broker” hyperlink 1402 from the registration web page, then he is directed to the agency Registration page shown in FIG. 15. Here, the agency principal may enter agency identification information including his name 1502, telephone 1504 and facsimile 1506 numbers, address 1508, tax identification number 1510, insurance agency license number 1518 and state of license 1520. The agent may also specify the agency's web site home page 1522, if any. Once this information is entered and the user clicks on the “next” button 1524, step two of the agency registration process is entered.

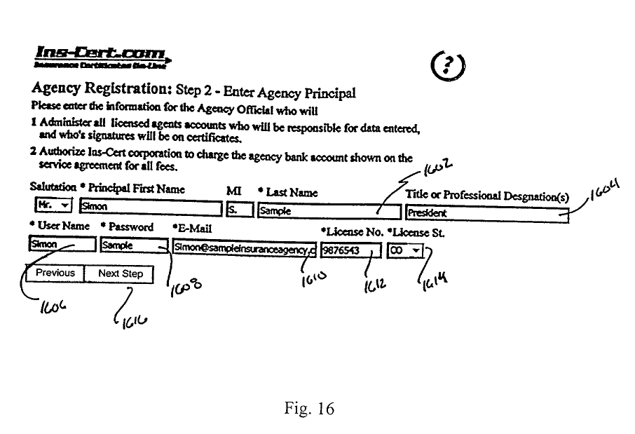

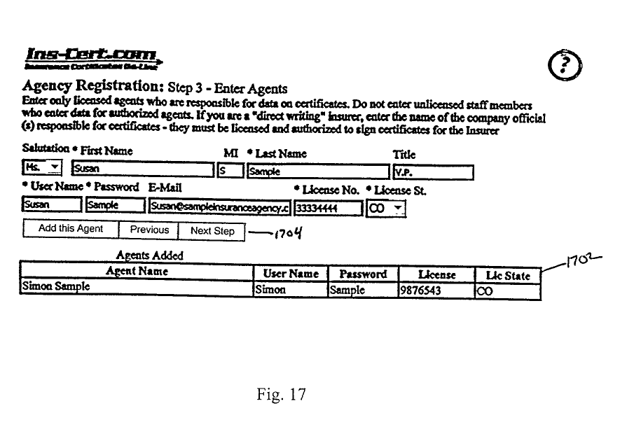

FIG. 16 displays the second agency Registration screen, where a user performs step two of agency registration. In step two, the agency principal registers his name 1602, title 1604, user name 1606, password 1608, e-mail address 1610, license number 1612 and license state 1614 with the system. The principal must register separately from other agents, because the principal has the sole privilege of adding or deleting agents and changing agency information. The agency principal may also view what has been entered by other agents within the agency, but other agents may only see records for which they are the agent-of-record. Clicking the “next step” button 1616 advances the system to step three of the agency Registration process, as shown in FIG. 17.

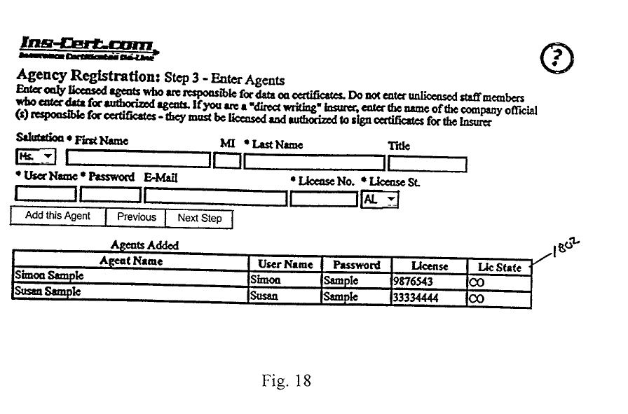

Step three of agency Registration allows the principal to enter other agents for the agency, with the same data required as for the agency principal. When first viewed, the third agency registration screen (shown in FIG. 17) shows the principal as the only registered agent. As the principal adds additional agents, this screen is updated to display data for each such agent. The data is shown under the “agents Added” header 1702. An example of the updated step three of agency Registration screen may be seen in FIG. 18. When the principal clicks the “Next Step” button 1704 on the web page, he is taken to the agency Service Agreement screen.

Blocked Agency Checking

The system administrator may block an agent or agency by logging into the system as an administrator and altering the agent's user name and/or password with a secret character change. When the blocked user attempts to register as an agent, the system looks in the table of blocked agents, removes the secret characters, and looks for a match. If a match is found, an alert box is displayed: “We are sorry, but there is a problem with your registration. Please contact the system administrator—see “Contact Us” on the Home Page [OK].” When the user clicks OK, the registration information is deleted and the user is taken back to the Home Page.

Fees

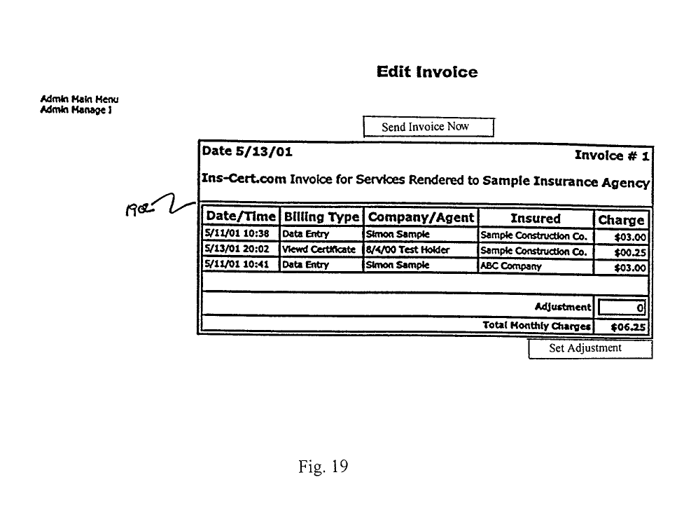

Generally, the system automatically tracks each transaction and compiles and sends an e-mail invoice to each agency principal at the end of each month. An example of such an invoice 1902 is shown in FIG. 19. In the present embodiment, an agency is charged a $3.00 data entry fee each time an agent enters data into the system. However, each agency is limited to one charge per insured per day. Further, each time a certificate holder views data about an insured, each agency whose agent(s) have data represented are charged 25 cents, again limited to one charge per holder-insured-agency combination per day. Alternative embodiments may impose different fee structures.

Agent Functionality

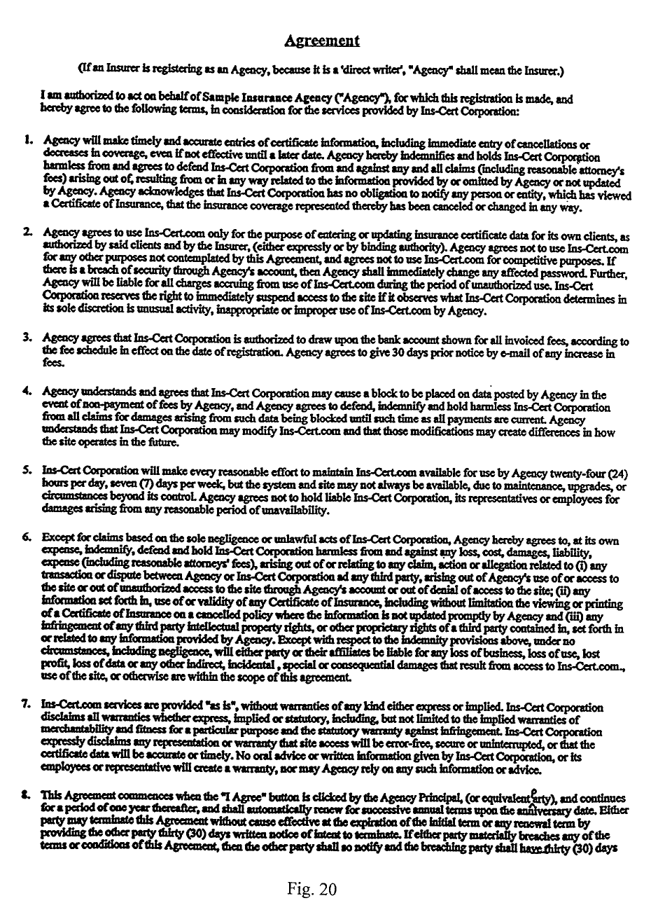

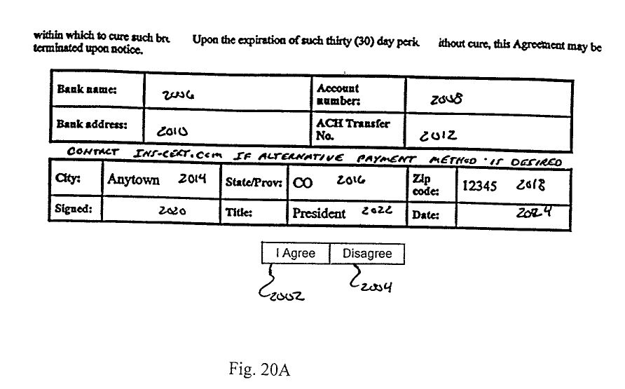

An example of the agency Service Agreement is shown in FIGS. 20-20a. The agency Service Agreement page includes an on-line “agree” button 2002, which allows immediate use of the system by agent(s) without requiring that a physical, signed agency Service Agreement (“Agreement”) be received by the system operator. Rather, by clicking the “agree” button 2002, the agent indicates that the terms of the agreement are acceptable. The agreement may also contain space for the principal to enter its bank name 2006 and address 2010, bank account number 2008, and ACH transfer number 2012, thus enabling the system operator to charge a bank account for fees earned. The agreement may also contain an option for the principal to agree to pay a deposit to the system operator or make other agreeable payment arrangements.

When the principal or other agent presses the “agree” button 2002, an alert box (not shown) is displayed. The alert box reminds the agent to print the Agreement screen for signature and mailing to the administrator, and includes an “OK” button which the agent may click to suppress the alert box.

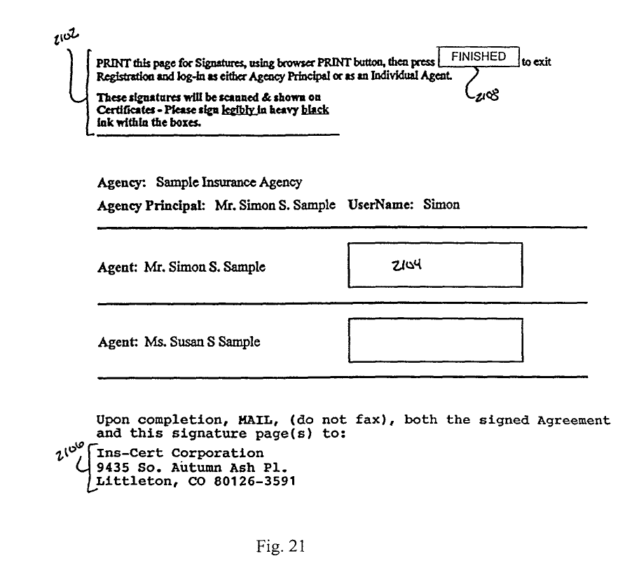

Pressing “OK” in the alert box takes the principal to the Signatures Page, shown in FIG. 21. However, clicking the “disagree” button 2004 aborts the registration process, returns the agent to the Home Page, and informs the system operator that the agent has declined the Agreement. Generally, the system informs the system operator via an electronic message, although alternative embodiments may convey this information differently. For example, an alternative embodiment may simply store a list of all agents who decline the Agreement for later review by the system operator.

The Signatures Page, shown in FIG. 21, displays instructions 2102 to the agent to print, sign, and mail a copy of the page and Agreement to the system administrator. Generally speaking, the agent must sign in the signature block 2104 provided. The system administrator's mailing address 2106 is also given in order to facilitate return of the printed Signature Page. The system administrator may then scan the signatures and enter the signature files into the system, so that an image of the corresponding agent's signature may appear on the insurance certificate database report (“cert”) in any coverage section with data entered by that agent.

The agent may exit the Signature Page by clicking the “finished” button 2108.

The Log-In Page

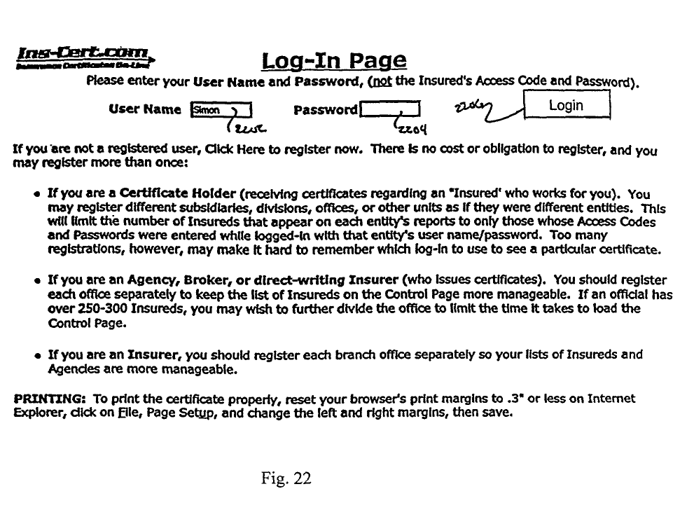

Upon completion of the agency Registration process, as well as upon pressing the “Log-In” button on the Home Page 320, the user is taken to the Log-In Page. The Log-In Page is displayed in FIG. 22. At the Log-In Page, the agency principal or other registered agent is instructed to enter a user name 2202 and password 2204. This page also gives advice to each type of user about multiple registrations.

The Agent Control Page and Agent Functionality

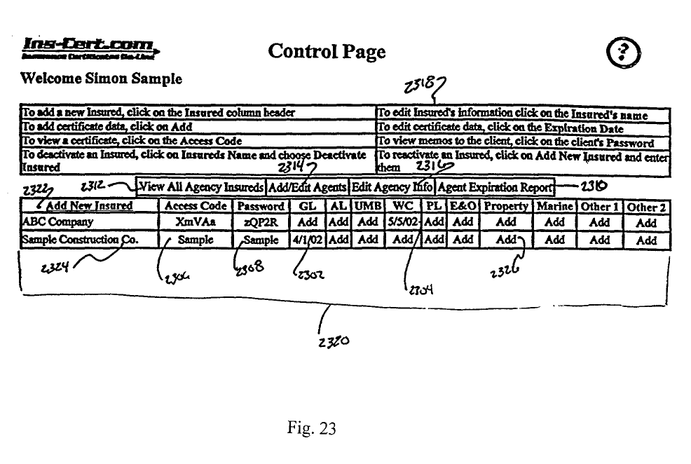

When the agent logs into the system, he sees a “Control Page,” as shown in FIG. 23. Generally speaking, the function of the Control Page is to summarize insurance data entered by an agent for all insureds, and to act as a launch point for navigation to other pages and functions. The Control Page is typically updated whenever new data is entered, displays data current as of the date logged-in, and allows navigation to each data entry screen for each insured.

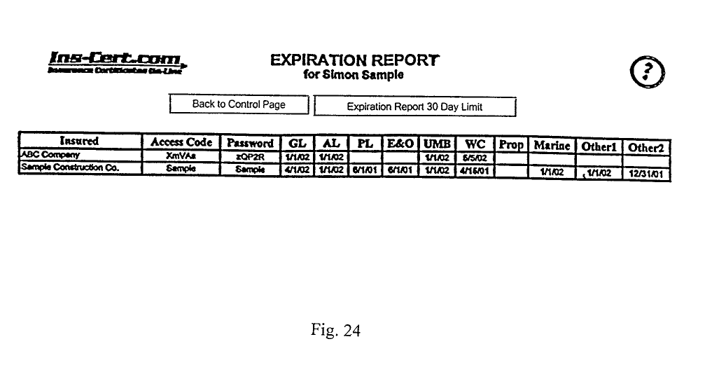

The agent Control Page displays the policy expiration date 2302 (or cancellation date 2304, if earlier) and date for each coverage for each insured, thus serving as an expiration report for the agent. This reminds the agent of any upcoming policy expiration dates. The agent Control Page also displays the access codes 2306 and passwords 2308 for each insured for whom the agent has entered data in two separate columns, as a reference for the agent. Further, the agent Control Page displays a button 2310 labeled “Expiration Report” which, when pressed, displays a table of insureds with expiration dates for each coverage, but without the navigation buttons, making it more suitable as a printable report for reference by the agent. A sample Expiration Report is shown in FIG. 24.

When a principal logs in and views the agent Control Page, a “View All agency insureds” button 2312 is displayed. In the present embodiment, this button is shown only to a principal, although alternative embodiments may display the button for other users as well. Clicking the “View All agency insureds” button 2312 changes the control page to display all records entered by any agent within the agency, and changes the button to read “View My insureds.” Clicking this “View My insureds” button 2312 again toggles back to viewing only those records entered by the agency principal.

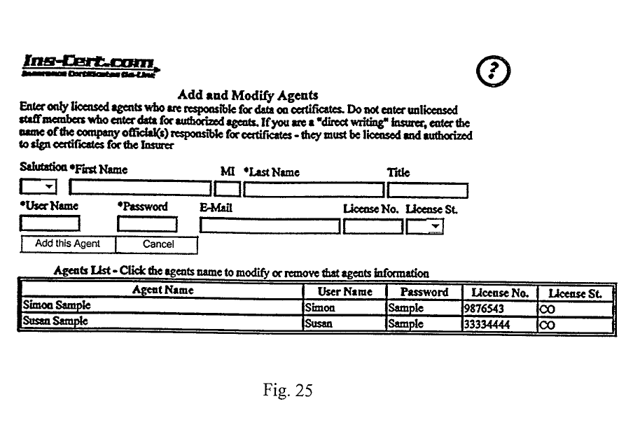

A principal viewing the agent Control Page may also see a button 2314 labeled “Add/Edit agents.” Again, this button is shown only when the user is a principal. Pressing this button takes the principal to an “Add and Modify agents” page, shown in FIG. 25. In the present embodiment, the “Add and Modify agents” page is identical to the “agency Registration—Step Three” screen described above. From the “Add and Modify agents” page, the principal may add and delete individual agents. In the present embodiment, deleting an agent only blocks that agent's ability log into the system, thus preventing that agent from editing or entering data, rather than purging the agent from the system. Alternative embodiments may permit agents to be deleted, rather than blocked.

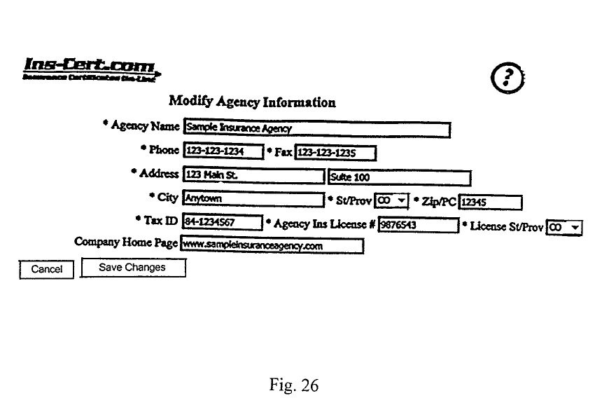

From the agent Control Page, a principal may also edit previously specified agency information by clicking the “Edit agency Info” button 2316. As above, this button 2316 is shown on the agent Control Page only when a principal logs into the system. Pressing this button 2316 takes the principal to the Edit agency Screen, as shown in FIG. 26. The Edit agency Screen is essentially a copy of the registration “Step One” screen (FIG. 8), from which the principal may edit registration data for the agency.

The agent Control Page shown in FIG. 23 contains an instruction area 2318 detailing the eight primary functions performed by the agent, and a thirteen column table 2320 of all insureds already entered by the logged-in agent. The Control Page table 2320 automatically arranges all insureds in alphabetical order, and the system generates a random access code and password after data is entered in any coverage section. An alternative embodiment may create the access code and password as soon as the insured information is entered, without requiring that any data be entered. This access code and password combination is unique to each insured, and is not changed by different agents entering data for the same insured.

In addition to the access code and password, the other columns in the Control Page table are “GL” for general liability, “AL” for automobile liability (including garage liability and auto physical damage, with a schedule of vehicles and loss payees), “UM” for umbrella/excess liability, “WC” for workers compensation, “PL” for pollution liability, “E&O” for professional liability, “Property” for building and personal property coverages (including property schedules and mortgagees or loss payees), “Marine” for inland marine coverages (including schedules of equipment and loss payees), and “Other 1” and “Other 2” for the free-form sections into which agents may enter unusual coverage information. Alternative embodiments may delete or add columns as necessary, or may use different column labels.

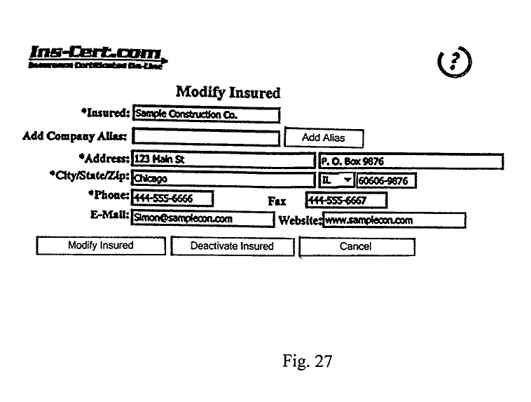

Finally, an agent may navigate from the agent Control Page to a variety of other web pages. For example, the agent may click the first column header 2322 of the Control Page table, entitled “Add New insured”, in order to access the Add New insured page described below. Also from the agent Control Page, the name 2324 of the insured functions as a hyperlink to the Modify insured page, shown in FIG. 27. While viewing the Modify insured page, the agent may change the insured's name, alias, address and other information added when first entered.

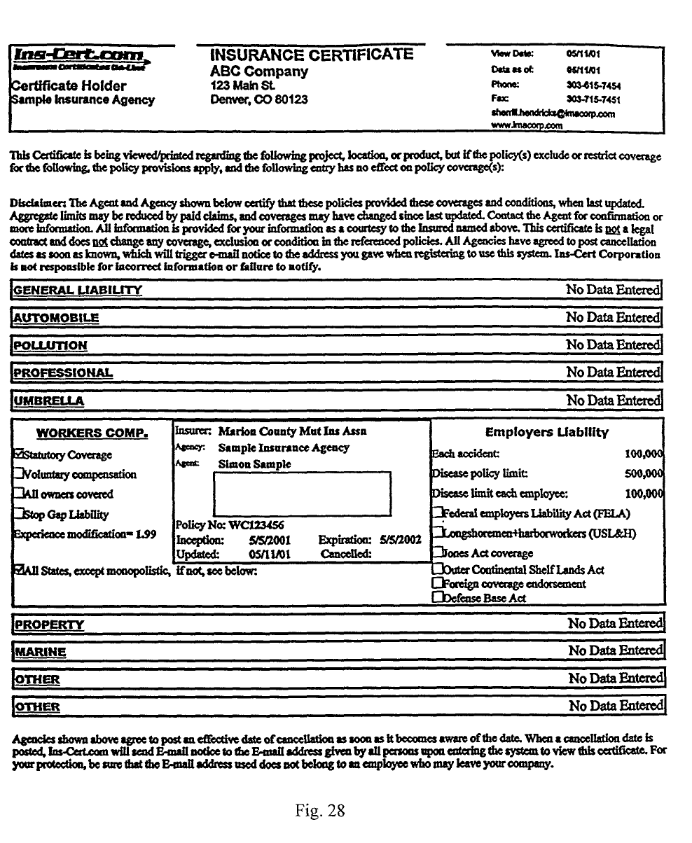

Clicking an insured's access code 2306 transfers the agent to an insured's certificate, which will only display data entered by the agent who is logged-in. If no data was entered, or data was entered by another agent for this same insured, that coverage section will display the coverage name and “No Data Entered.” An example is shown in FIG. 28. When the agent views a certificate, the agency name appears under the title “Certificate Holder.”

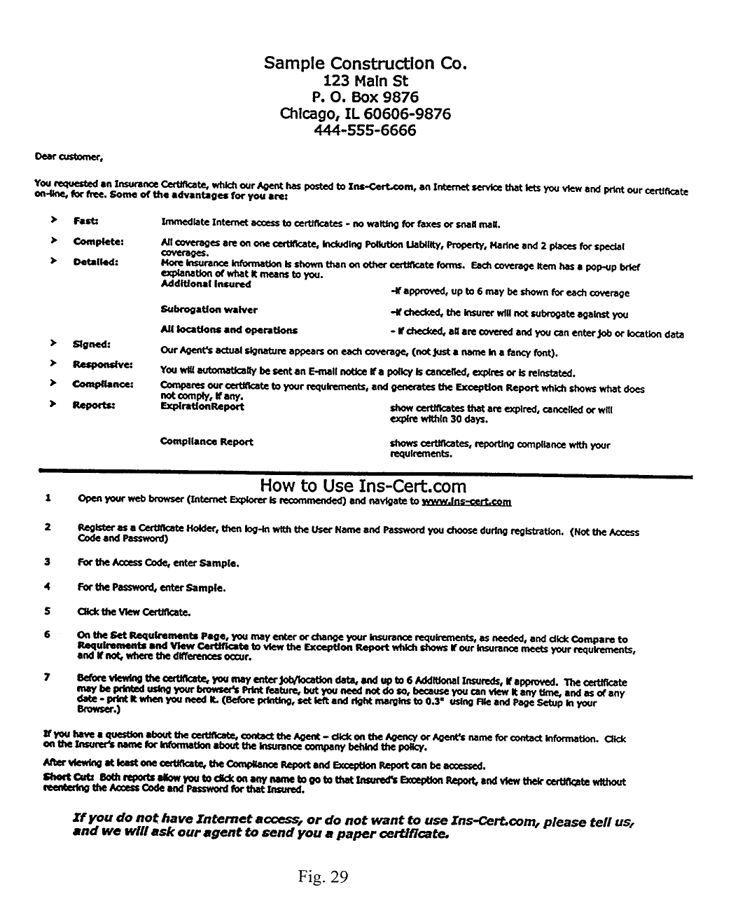

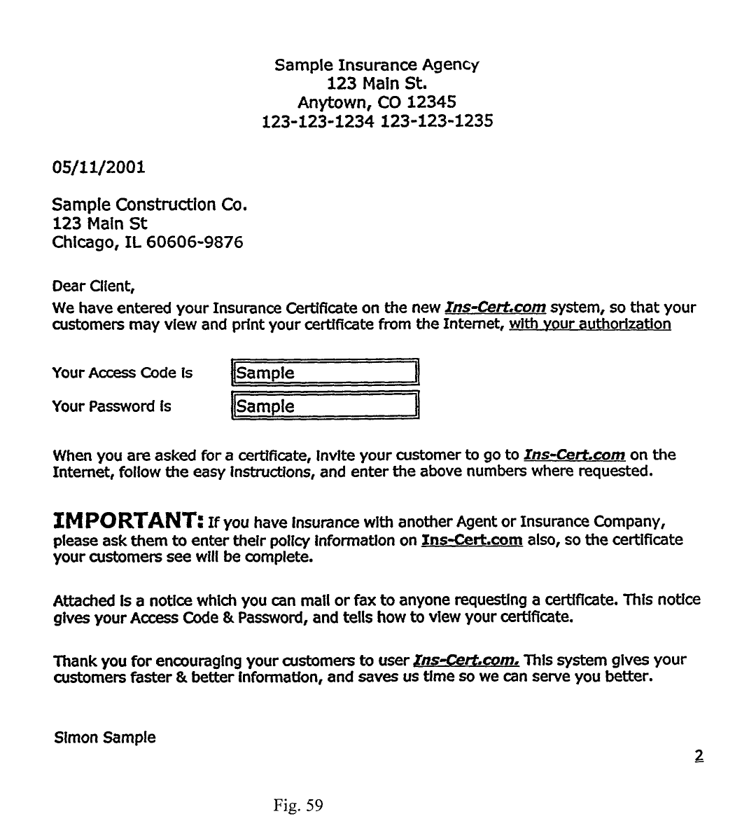

Also from the agent Control Page, the Password 2308 for each insured functions as a hyperlink to a two-page memo displayed on the “Client Memo” web page. This web page is shown in FIG. 59. The “Client Memo” is a memo from the agent to the insured, notifying the client that his certificate data has been posted to the system, giving the access code and password, and other instructions. The “2” at the bottom of the page (not shown) is a link to the Customer Memo web page, shown in FIG. 29. Alternative embodiments may change the way these memos are accessed, displayed, or the wording on the memos, and may include automatic electronic mailing of these memos to the insured.

Adding a New Insured

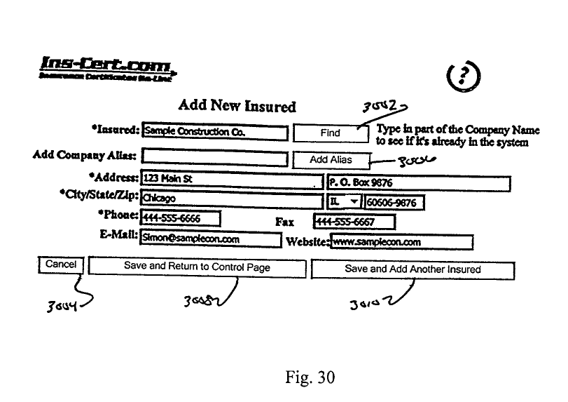

The Add New insured page is shown in FIG. 30, and may be reached from the agent Control Page. The Add New insured page contains basic information identifying an insured, but also allows the agent to enter (via the “Add Alias” button 3006) an unlimited number of alias names, (affiliates, subsidiaries, d/b/a's, and so on), as may be included on the same policies as the insured.

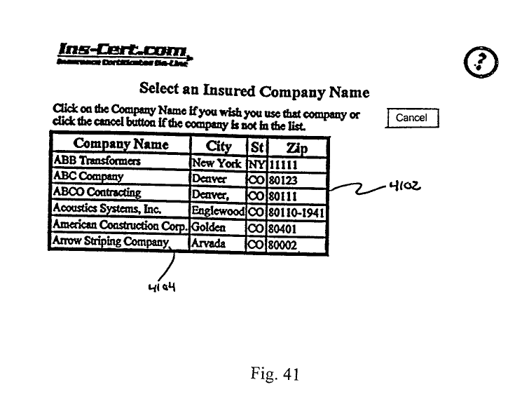

Upon entry of a part of the insured's name in the Add New insured page, the agent may press the “FIND” button 3002, in response to which the system displays a table of names, cities and zip codes of previously entered insureds with similar names, as shown in FIG. 41. The system pulls up a table 4102 showing all the names, cities and states of Insurers whose names begin with the same letters. The agent is prompted to select the correct Insured by clicking on a corresponding name 4104, after which the system goes back to the data entry screen and inserts the selected name. If no insureds with similar names exist, the system may inform the agent that no matches are found. The agent may then enter the rest of the identifying information, thus setting up a new insured record. If the insured that the agent wants to enter is on the table, he clicks on the name to select it, and the previously-entered data populates the data entry screen. If at least one record appears, but the agent does not find the right insured, he is instructed to press “CANCEL” 4106 and allowed to enter the information for a new insured.

In an alternative embodiment, the Add New Insured page may not display anything more than the box in which the agent is instructed to enter part of the new insured's name, and a “NEXT” button, to prevent agents from skipping the “FIND” button and entering as new, insureds that are already in the database.

At the bottom of the Add New Insured screen is a clickable button 3004 to cancel the current transaction, which returns the agent to the agent Control Page without saving the current entry. The “save and return” button 3008 permits the agent to save the entry and return to the agent Control Page, while the “save and add” button 3010 allows the agent to save the current entry and enter another new insured.

Adding or Changing Coverage Data for Existing Insured Records

Any agent (including an agency principal) may add or change insurance coverage data for any pre-existing insured. When viewing the Control Page table on the agent Control Page (FIG. 23), any column representing a coverage in which the logged-in agent has not entered any data displays the word “Add” to indicate that the agent may add coverage data. The “Add” entry 2326 functions as a hyperlink. When clicked, the corresponding data entry screen for the coverage defined by the column and the insured defined by the row is loaded as detailed below. For any column on the Control Page table representing a coverage in which the logged-in agent has entered data, the expiration date 2302 or cancellation 2304 date for that policy data is displayed and the agent may click on the date to access the data for editing. Once the agent is in any of the data entry screens, the agent may click on any coverage button to go to any other coverage data entry screen. Each time the agent does so, the data entered or edited is saved, as well as when the agent clicks on the “Return to Control Page” button.

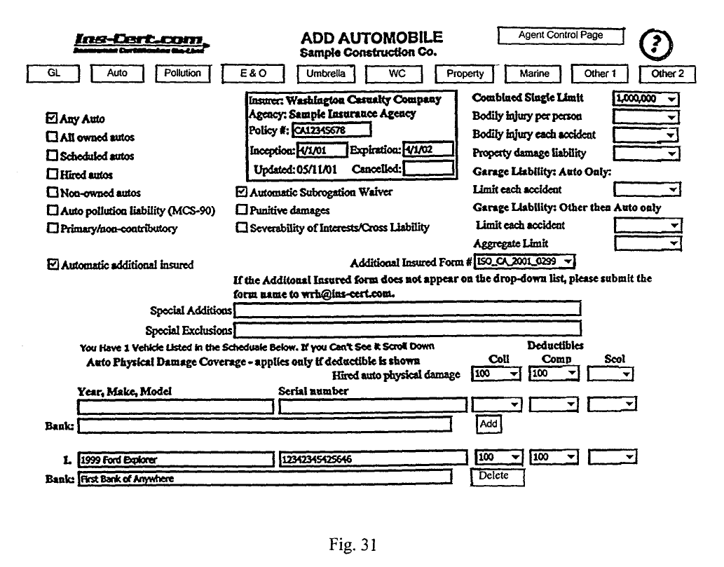

To add coverage data, the agent clicks on any “Add” 2326 or expiration date 2302 for the desired insured (since the agent may jump from one coverage to another once entered into the data entry screens). If no data has been entered, the screen title will say “ADD GENERAL LIABILITY,” “ADD AUTOMOBILE” and so forth, depending on the type of insurance the agent seeks to add. Sample screens are shown in FIGS. 31, 32, and 33. When the agent enters new data and presses another coverage tab or the “Return to Control Page” button, all data entered is saved with an effective date equal to the inception date of the policy entered, regardless of the date of entry of the information. If data has been entered by the agent for a coverage, the page title reads “MODIFY GENERAL LIABILITY” if the insurance policy is a general liability policy, “MODIFY AUTOMOBILE” if the policy is an automobile policy, and so forth.

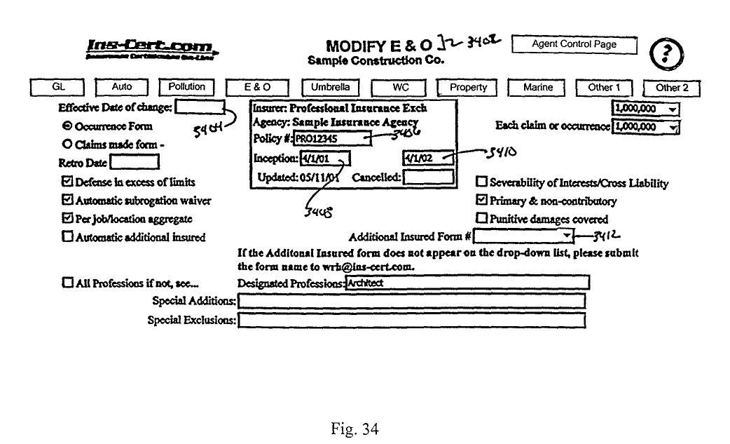

If the agent clicks on an expiration date 2302, the agent is taken to a “Modify” screen. From the “Modify” screen, the agent may alter the insured's policy information. Generally, each “Modify” screen displays a title 3402 corresponding to the type of insurance being modified. For Example, FIG. 34 displays the “MODIFY E&O” screen. Each “Modify” screen has an “Effective Date of Change” data entry box 3404. The effective date of change must be entered in this box 3404 in order to save any changes to the data for that coverage. If the data entered is new, the system adds whatever is entered and shows the effective date of the policy as the effective date of the data. This permits the system to track change dates, so that when the holder chooses to view the data as of a specified date, the invention will display information that is (or was or will be) in effect as of the desired date. Sample data entry screens are shown in FIGS. 31, 32, 33, 34, 35, 36, 37, 38, 39, and 40.

Upon accessing a data entry screen, the system prompts the agent to “First Select an Insurer,” and in place of the name of the Insurer is a prompt stating “Click Here to Select the Insurer.” Clicking on that link takes the agent to an Insurer Selection Screen, that is similar to the “Select an Insured” screen of FIG. 41, but lists insurers rather than insureds. Here, the agent is prompted to enter the first few letters of the Insurer's name and press the “FIND” button (not shown). The system pulls up a table 4102 showing all the names, cities and states of Insurers whose names begin with the same letters, such as the table shown in FIG. 41. The agent is prompted to select the correct Insurer by clicking on a corresponding name 4104, after which the system goes back to the data entry screen and inserts the selected name. Note that the names of the agency and agent are automatically entered for any data entry, having been pulled from the agent's registration. This precludes entry of data without knowing who entered it, which removes any incentive to enter false information.

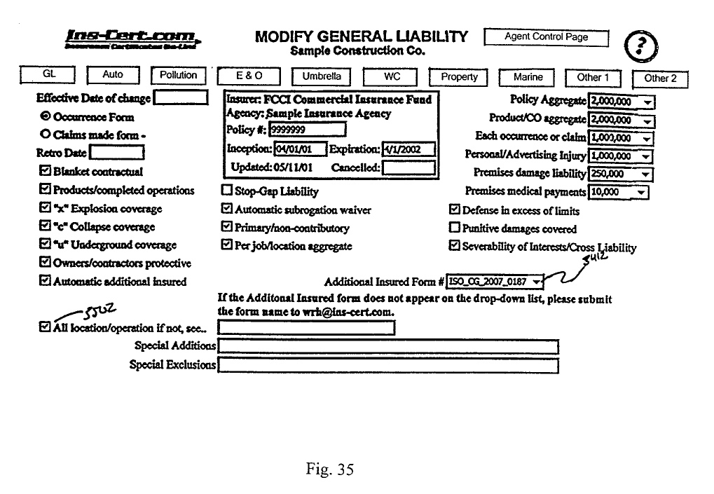

Returning to FIG. 34, the agent is required in each “Modify” or “Add” screen to enter a policy number 3406 and dates of inception 3408 and expiration, as well as certain other key information, without which saving the data would be meaningless. Various alert messages on a red background tell the agent what he has done in error, rather than allowing him to enter erroneous information. Throughout the system are numerous validations in order to prevent entry of data that would reflect impossible insurance policy conditions. For example, in the modify screen shown in FIG. 35, a policy aggregate cannot be less than the “Each Occurrence” limit. In another example, also with respect to FIG. 35, if the “All locations/operations” box is not checked the agent must complete the nearby field to indicate what location or operation is covered by the policy being certified. The system validations prevent such impossible conditions from being entered.

Clicking on the “agent control page” button or any of the coverage buttons, from any of the data entry screens automatically saves any entry made by the agent and triggers a $3 data entry charge to the agency, with restrictions as previously described. If the agent clicks coverage buttons to view the data entry screens, but does not make any change in any data, no data entry fee is charged.

Additional Insured & Waiver of Subrogation Functions

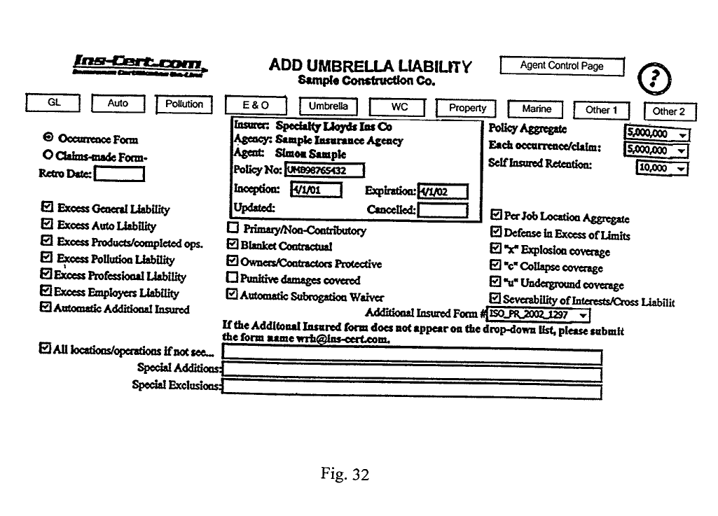

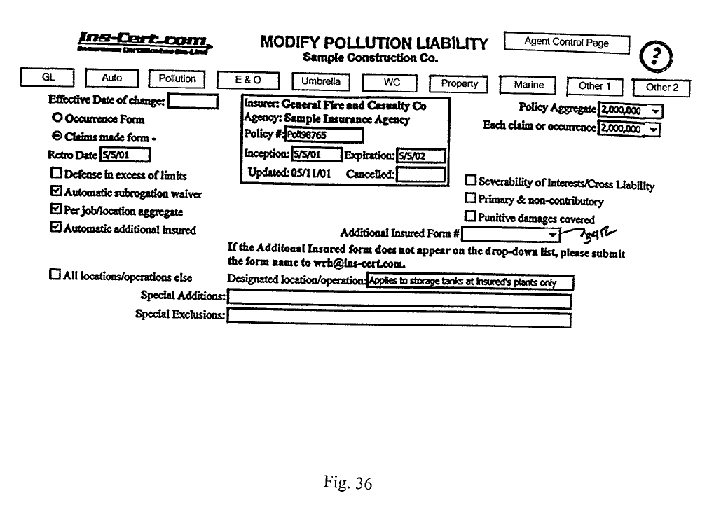

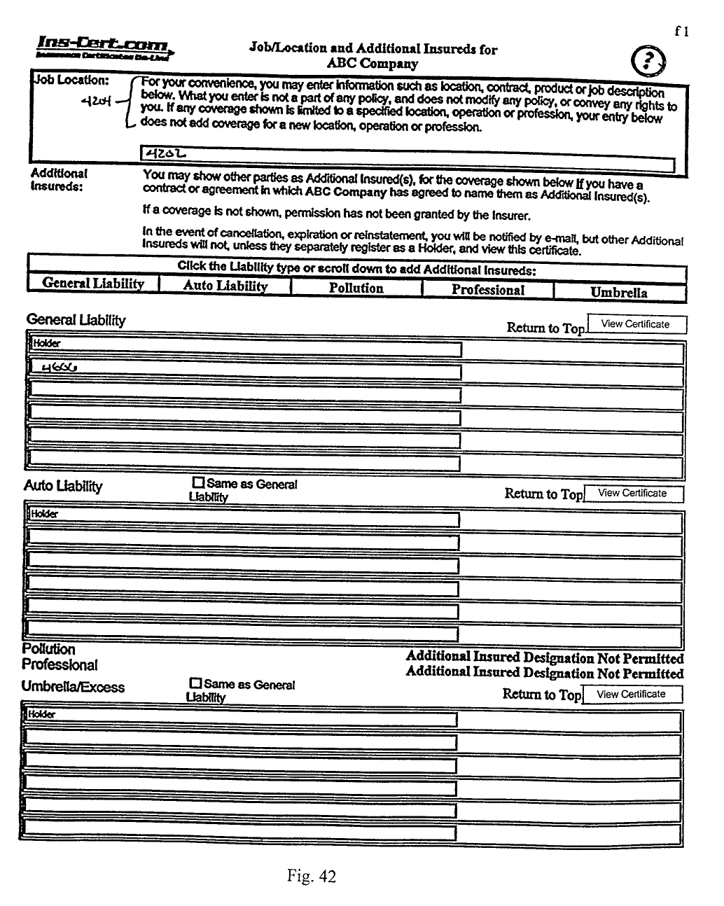

On the General Liability (FIG. 35), Auto (FIG. 31), Pollution (FIG. 36), Professional (FIG. 34), and Umbrella (FIG. 32) data entry pages, there may be a check-box labeled “Automatic Additional insured.” There may also be a drop-down selection box 3412 from which the agent can select an additional insured (AI) form number to display on the certificate, so that the holder may know which endorsement form affords such coverage. Likewise, there may be a drop-down box (not shown) for selection of the form affording a waiver of subrogation benefit on the same coverages. A similar box may be present in the workers compensation coverage. In both cases the holder may be permitted to designate the AI to be covered, and those to whom the Waiver of Subrogation applies, on the “Job/Location & Additional insured” screen, shown in FIG. 42. Typically, the specified AIs are parties required by contract to be named as “additional insureds.”

Selecting an AI form number also links the appropriate forms for display from the certificate. If the agent has checked the “Automatic Additional Insured” box and selected “CG2010 1185” from the list of forms, for example, the holder will view on the certificate the statement “The following parties are named as Additional insureds, if required by contract or agreement before a loss, per form CG_{—}2010_{—}11_{—}85.” The phrase “form CG_{—}2010_{—}11_{—}85:” will be a hyperlink which, when clicked by the holder, will cause a copy of that endorsement form to appear on the screen populated with the insured's name, Insurer name, policy number, inception date, expiration date, and the names of the parties designated by the holder as additional insureds. An alert box will appear inviting the holder to print the form using the browser PRINT button, and use the BACK button to return to the Certificate.

The present embodiment also includes a function whereby the agent is automatically sent an electronic mail memo from the holder, informing him that the holder has a contract with the insured requiring that certain parties be named as Additional insureds. The memo takes the names that were entered by the holder and incorporates them into the memo so that the agent knows who is expecting the additional insured benefits. The memo also requests immediate notification if there is any reason why these named additional insureds may not receive these benefits. This automatic e-mail memo is generated as soon as the holder clicks on the “View Certificate” button located on the Job/Location and additional insured page, and is sent to the appropriate agent for each coverage for which the holder has entered a name. Note that the memo is generated only if at least one name is entered as an additional insured.

Similarly, if the “Subrogation Waiver” box on the data entry screen is checked by the agent, the corresponding Certificate section may display the sentence “Insurer waives its right of subrogation against {holder Name}, if required by contract or agreement before a loss.” In another embodiment, the data entry screens may have a drop-down box allowing the agent to select the form number of the endorsement form which waives subrogation. Such an embodiment may likewise display the multiple parties designated by the holder and the Subrogation Waiver form numbers as hyperlinks to display the actual populated forms.

The Customer Memo

Turning now to FIG. 29, the Customer Memo is designed for use by the insured to notify the insured's customers (certificate holders) that the insured's certificate information has been posted to the system and may be accessed via a network. This memo gives the holder several advantages of the system, numbered instructions for using it, and the insured's access code and password.

The Certificate Holder Registration Page

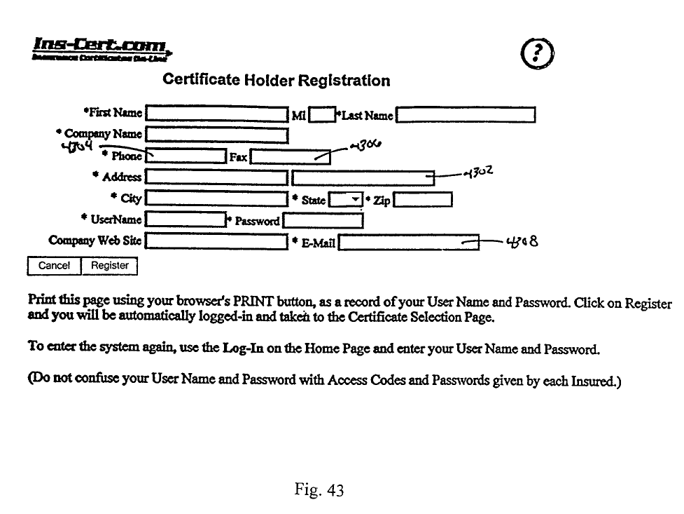

Selecting the “holder” hyperlink 1404 from the Registration Selection page of FIG. 14 directs a user to the holder Registration page, as shown in FIG. 43. A holder may register in a manner similar to an agent, above. The holder typically supplies his address 4302, telephone 4304 and facsimile numbers 4306, and so forth, including an electronic mail address 4308, which enables the system to generate and send electronic notices to the holder. The holder may also enter a list of branches, locations, projects or other categories in a “Division” function (described below), in order to limit the contents of later-described reports.

The holder Registration page may also contain a combination box (not shown), allowing holders to choose a referring agency from among all registered agencies. By designating a referring agency, a holder causes the referring agency to be credited with a referral fee. A system administrator report may list all agents and agencies, and a list of all referring holders for each one, as well as the number of viewings in the past month and year since the holder registered.

An alternative embodiment may function like the Insurer selection on the data entry screen. In such an embodiment, the system would require the holder to enter his company name (or last name, if an individual) and in response would display all registered holders whose name begins with the same letters. The system may then give a hint for the user name and password; for example, the first letter/number of each followed by dots (i.e., “User Name=A . . . & Password=B . . . ”). A prompt may then ask the holder to select one of the displayed registered holders, or click a “CANCEL” button to enter a new registration. If the holder selects one of the displayed names, he may still be required to enter his user name and password for security purposes. This helps avoid duplicate registrations caused by people not remembering user names and passwords. Additionally, the alternative embodiment may display a button labeled “E-mail my User Name & Password” may be present which, if pressed, causes the system to send an electronic message to the holder's registered e-mail address. Alternative embodiments may not request the holder's electronic mail address.

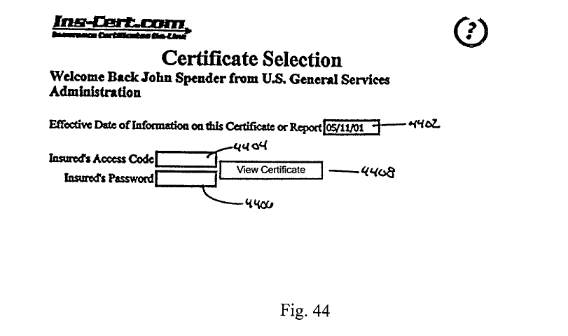

Upon registration, the holder is immediately logged-in and sees the Certificate Selection Screen, as shown in FIG. 44. The Certificate Selection Screen only shows a holder's name and company, an effective date of information 4402 (which defaults to the current date), and fields for him to enter the insured's access code 4404 and password 4406. Once all information is entered, the holder may click the “View Certificate” button 4408.

In the present embodiment, once the holder has entered at least one access code and password combination and viewed the corresponding COI, this Certificate Selection Screen changes to include a table of all previously viewed insured names, along with the corresponding access codes and passwords. In an alternative embodiment, this table of previously-viewed certificates will be replaced with the “Division Function,” as detailed below. Once the holder has entered at least one access code and password, the Certificate Selection Screen will also show buttons labeled “view compliance report” and “view expiration report.” These buttons do not appear at first, because there are no records to populate either report.

Division Function

The Division function allows up to five levels of categories to designate divisions such as subsidiary, division, region, branch office, project, territory, location, or product, for the purpose of grouping and limiting the number of insureds appearing on Compliance and Expiration Reports. Each level allows the holder to select from existing Divisions, or create a new one. For each holder, the system retains all previously entered Divisions and allows them to be selected from a list and viewed by clicking on the button the divisions may be viewed in a tree-structure using the WINDOWS Explorer tool or a similar navigational function. If the holder clicks on one of the existing levels, the system fills in the applicable boxes below, allowing the holder to accept or further define the category by adding a new, lower-level category. Each level selection/entry box may also allow for drop-down selection or data entry. When the holder initially accesses the Division function, lower levels are grayed-out and only level one may be selected from what is in the system for the holder. If the holder either opens the tree view and selects a category, or selects a category from the existing level one drop-down, then the selected category(s) are saved in the appropriate level box(s), and the next available open box is opened.

Requirements

When the holder presses the “View Certificate” button, he is taken to the general liability “Requirements” page (in the present embodiment, this page is entitled “Set Requirements”), which prompts for and allows entry of the holder's insurance requirements in almost the same way that the agent enters the data about the insured. On this page is a button allowing the holder to “Clear Requirements” (in the present embodiment labeled “Drop Requirement”), which is a short-cut to clear all entries.

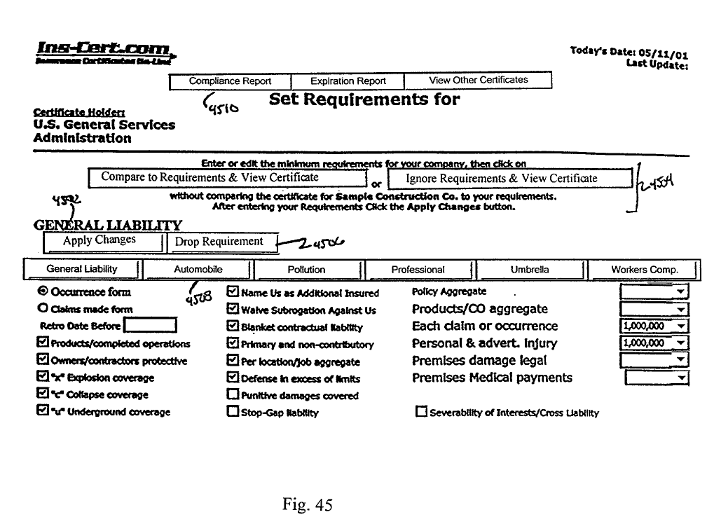

FIG. 45 displays the “Requirements” page. Before data can be entered into any “Requirements” screen, an alert box appears with the following message:

“Enter insurance limits/coverages which are required by your contract or agreement.

If no requirement is entered, you will not be alerted to a deficiency, but if you enter more requirements than are in your contract, the Reports will erroneously show non-compliance.

If you enter no requirement for a coverage, no policy information will display on the Certificate.

You must save requirements in one of the 5 Requirement Sets, but you may change them at any time. Click on “Select . . . ” to show and use a previously stored Set, or click on “Save . . . ” to save currently displayed requirements as that set. You may enter names in the space provided, to indicate the use of each.”

An “OK” button appears immediately below this message.

Clicking the OK button closes the alert box, permitting entry into the coverage and limit fields. Clicking on any of the coverage tabs saves the entered requirements in an unseen Requirement Set 0, which is temporarily stored in the database and transfers the user to another coverage. The temporarily saved data is erased as soon as the holder clicks on a “Save as:” button to save what was entered as one of the five displayed sets. In the present embodiment, there is also an “Apply Changes” button, which saves entries. Alternative embodiments may omit this button.

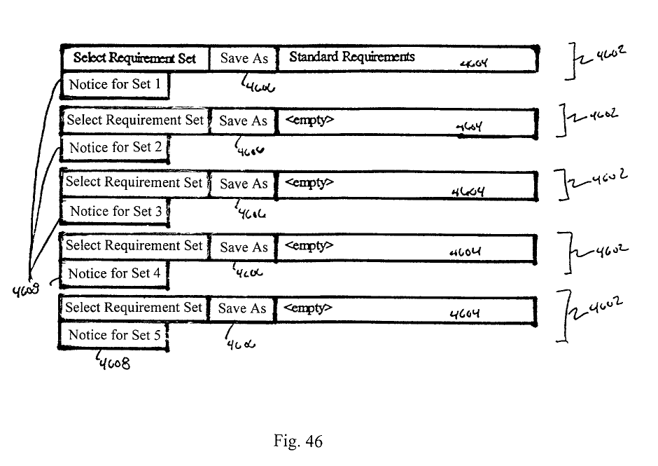

As shown on FIG. 46, under the title “set requirements for,” the system displays the name of the holder on the left side. In an alternative embodiment, if the holder has selected one or more Division category(s), those will appear after the holder's name, so the holder knows for which Division the requirements are being entered or edited.

In another alternative embodiment, the holder who first registers may be permitted to enter an alternative password to be used by other persons in the holder's organization, who will have full access to all but the Requirements, so they can use the system, but may not change any requirements.

Requirement Sets

As shown on FIG. 46, the Requirements (presently labeled “Set Requirements”) page may also display five sets 4602 of buttons and associated fields. The holder may enter labels into the fields 4604 in order to give each set a name. By default, the fields all say “<empty>” until the holder enters some requirement data and presses one of the “Save” buttons 4606. After at least one set has been saved, the selected set is shown with a yellow background, indicating it is in use, while the others appear with a light gray background. If the holder saves requirements in a set without changing the label, the “<empty>” disappears, but if no requirements are saved in a set, the “<empty>” label cannot be over-written. When the holder saves requirements in one of the five sets, an alert box appears, reminding him: “To enter/edit the Requirement Set name, click in the box and type in a short description.”

If the holder clicks on one of the “Notice for Set_” buttons 4608, assuming the set is not empty, the system populates a version of the “Suggested Notification Letter” (FIG. 5) reflecting the requirements entered for that set, and displays the revised notice, which may be printed with the browser PRINT button, or electronically mailed to a recipient by clicking a button on the screen.

Generally, FIGS. 45 though 51 display different versions of the basic Requirements page. In one embodiment, all such pages and data entry pages contain graphics that look like file folder tabs (not shown)—each is a light gray color with a line underneath. Once a graphic is selected, its color changes to manila and the separator line disappears, making it appear to be a front file folder in a group. Additionally, the instructions 4504 in the top portion of the screen are moved to the left, the reference to the “Apply Changes” button 4502 and the button itself are removed, and the name of the coverage is removed. For reference, the instructions 4504 that are removed are those reading, “Enter or edit the minimum requirements for your company, then click on [Compare to Requirements button] or [Ignore Requirements button] without comparing the certificate for [insured's name] to your requirements. After entering your requirements click the Apply Changes button.” In an alternative embodiment that deletes these instructions, there may only be a “View Certificate” button.

The Set Requirements page includes a “Clear Requirements” or “Drop Requirements” button 4506. Again, this button allows a holder to quickly and easily clear all fields on the current page.

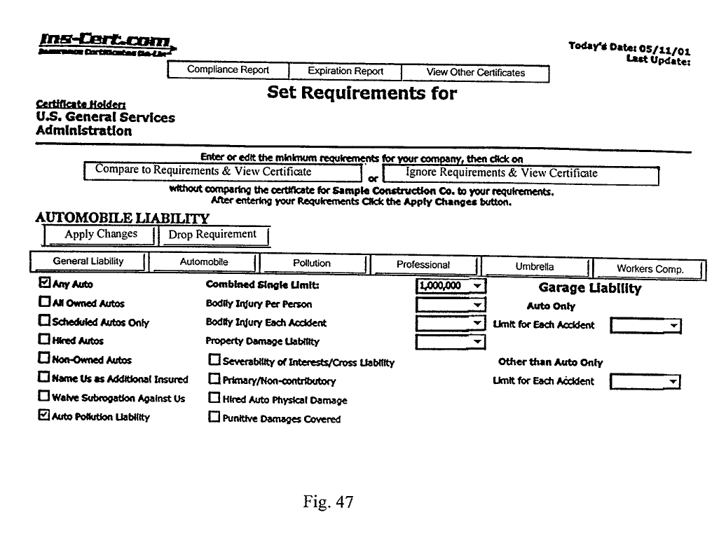

Clicking on any tab or button on the Set Requirements page saves the requirements in a temporary file, and changes the screen to one corresponding to whichever tab was pressed. For example, if the “Automobile” button 4508 is depressed, all data entered is recorded in a temporary file and the system displays the “Set Requirements for Automobile” screen, as shown in FIG. 47.

Should the holder click a “Save as Set_” button 4606 (shown in FIG. 25), the currently displayed requirements page is also saved to Set 0, after which all requirements in Set 0 are saved to the set selected. If no entry is made to a coverage, then no existing requirements in such coverage in the selected “Save as:_” set are deleted.

The Exception Report

In order to view an insured's coverage, a holder typically requests that the system generate an exception report. The exception report displays the results 5206 from comparing the requirements in the holder's selected set to the corresponding fields in the data set inputted by the agent for the record that was earlier selected by entering the access code and password. If no entry was made for a given requirement, or if coverage entered by the agent meets or exceeds the requirement in the holder's selected set, the requirement is not displayed on this report. If the holder did not save any requirements for a coverage, the phrase “Requirements Not Set” 5204 is displayed under the name of the coverage 5206. A sample exception report is shown in FIG. 52.

If a requirement is set but no agent has entered data for that coverage, the report displays “No Information Entered.” If both a requirement was set by the holder and data was entered by an agent, but the policy was either cancelled or expired as of the date of inquiry (entered by the holder), the coverage section displays “POLICY CANCELLED” or “POLICY EXPIRED,” respectively. If all coverages are current and comply with the holder's requirements, the only entry in the section is “Coverage Complies.”

Not shown on the illustration is a button next to the “Set Requirements” button 5202, which is labeled “Deficiency Notice,” and one of two alert boxes appear. If an electronic mail address is stored in the database for the insured, the alert box says: “This deficiency Notice has been e-mailed to the insured. Click OK button to view the memo. To print a copy for your records, use your browser PRINT button. Click your BACK button to return to the exception report.” If there is no e-mail address in the system for the insured, the alert box displays the message: “There is no e-mail address in the system for this insured. Click OK and use your browser PRINT button to print this memo for faxing or mailing. Use your BACK button to return to the exception report.”

The memo created by clicking the “Deficiency Notice” button is from the holder to the insured and states that the insured's insurance, as reported by the system, does not meet the requirements of the holder. The memo also requests that the insured's coverage be brought into compliance. This memo may include a table identical to the exception report showing the deficiencies.

From the exception report, pressing the Set Requirements button 5202 takes the user back to the Set Requirements page, and pressing the View Certificate button 5208 takes the user to the “Certificate Selection Page,” allowing the holder to choose another insured, or a report.

The Regarding and Additional Insureds Page

The regarding and additional insureds (“Re/AI”) page, shown on FIG. 42, has two functions. First, if the agents have checked the “All locations and operations” boxes 3502 on the input screens for general liability (FIG. 35), auto liability, pollution liability or umbrella liability, the top part 4202 of the page allows the holder to enter any text as a reminder of the purpose of viewing and printing the certificate. Disclaimers 4204 here and on the certificate itself clearly notify the holder that this is a convenience only, and nothing entered changes the policy certified. The second part of the Re/AI page invites the holder to enter names of parties who are required by the holder's contract with the insured to be named as additional insureds (“AI”) 4606. This is only permitted in coverages where the agent has certified, using a check-box, that that coverage contains “Automatic (or Blanket) Additional insured” Coverage. The name of the holder automatically populates the first space for any open coverage, but may be replaced, if desired, and the holder may enter up to five other AIs, all of which will appear on both the Certificate and AI form.

For coverages other than general liability, there is a box that the holder may check, indicating “Same as General Liability,” so the holder need not type in the names for every coverage.

In an alternative embodiment, the system may save all the AI names and “Regarding” information linked to the date, insured and holder information, allowing the agent and Insurer to view a table of AIs for each insured. The holder may also view a table of all AIs for each insured or for each “Regarding.”

If “Automatic AI” is not checked, the Re/AI screen will become an AI Request Form. Upon saving the data, the system will e-mail a request for approval to the agent. The agent may have a screen for viewing all AIs for each insured, showing the holder and “Regarding” information as described above. Wherever the agent authorized the AI, the date approved is shown. If not yet approved, a box is shown allowing the agent to authorize AI so that the holder can view the certificate with the approved AIs showing. When approved by the agent, the holder will see the approved AIs on the certificate. If not approved, the holder will see only approved AIs. Whether pre-approved by the agent designating “Automatic AI” or not, all AIs are available to both the agent and Insurer. In the present embodiment, the first line of the AI data entry is populated with the name of the holder. Thus, if the holder wants to be an AI, he need do nothing.

In the present embodiment, it is the holder's responsibility to notify the other AIs he has shown in the event of policy cancellation. In an alternative embodiment, the holder may enter the e-mail addresses of each AI which are retained in the database and linked to the corresponding insured, so that AIs receive the same e-mail notices of cancellation, expiration and reinstatement as the regular holder. An alternative embodiment may also display a list of all previously entered AIs partially matching a holder's entry in order to allow a holder to quickly and efficiently select from among already existing AIs.

The Insurance Certificate

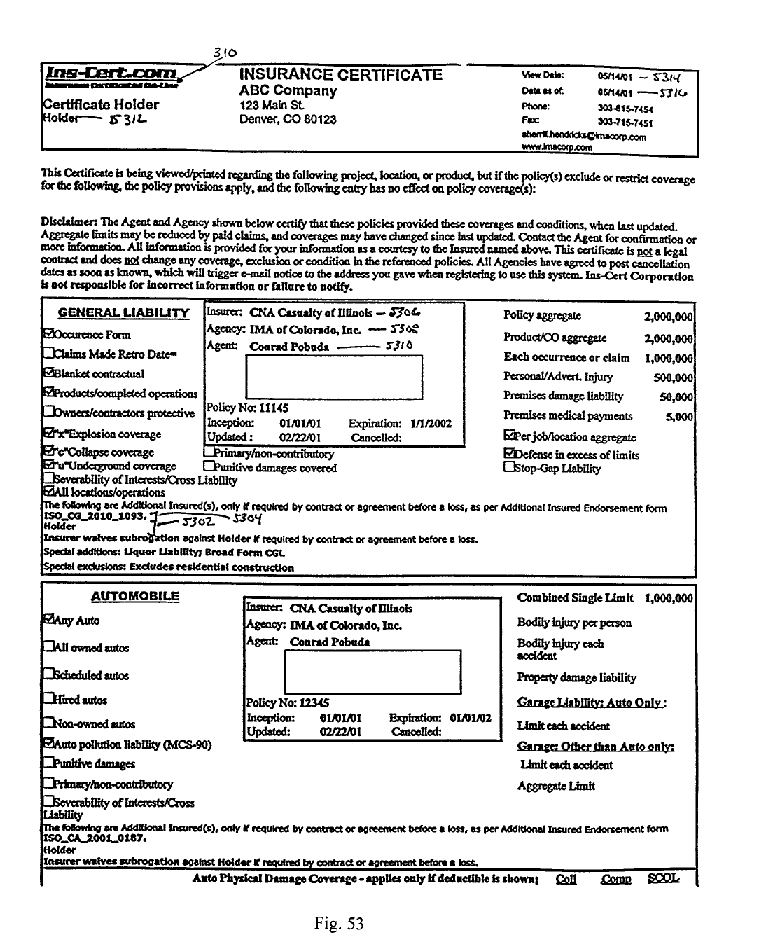

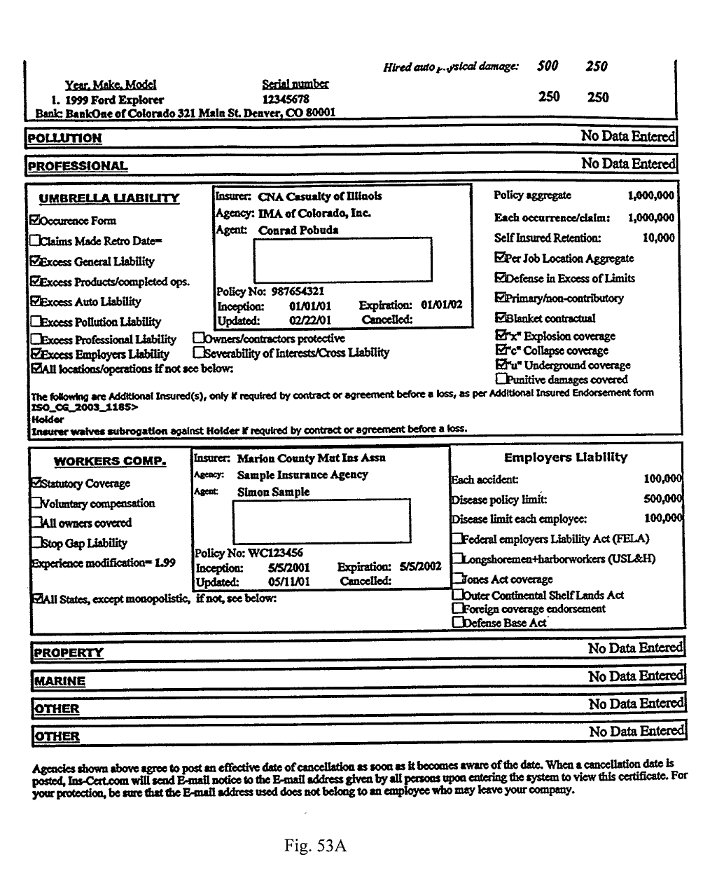

FIG. 53 displays an example of an insurance certificate with all coverages populated. If there is no data entered for a coverage, a one-line box appears with the name of the coverage and the words “No Information Entered.” Near the bottom of the General Liability section a list of all AIs 5302 is shown, as well as the AI form number 5304 input by the holder. Most of the labels on the certificate function as hyperlinks to simplified explanations of the various terms and coverages, both on the COI and the Requirements screens.

The Insurer's name 5306, agency name 5308, and agent name 5310 are hyperlinks to pages containing corresponding registration information, such as an agent's address, phone, and fax. In an alternative embodiment, the Insurer information may also contain advertising, promotional information, links to the insurer's web site, and/or a link (not shown) to the web page of A. M. Best & Company, on which the holder may view the current rating and other information about that Insurer. A. M. Best is a well-known company in the business of providing standardized ratings for insurance companies. The embodiment may also display a link (not shown) to the web page containing the Insurer's rating from Standard & Poors or other rating organizations.

If the holder hovers a cursor over the form number 5304, a display tells the holder “Click on the form number to view the actual form.” When the holder clicks on the AI form number 5304, the corresponding form is displayed, populated with (1) the names of all AIs, (2) the insured primary name, (3) the Insurer name, (4) the policy number, and (5) the policy inception and expiration dates. Substantially immediately, an alert box appears, saying:

“The form displayed here substantially represents the coverage certified by the agent, broker or insurer who entered the data into Ins-Cert.com. This may not look exactly like the endorsement attached to the captioned policy, but the agent, broker or insurer represents that the benefits afforded the parties named are substantially the same.”

If the agent has checked the box certifying that the policy includes a “Blanket Waive of Subrogation” (not shown), then the certificate will show the sentence regarding subrogation, as shown on FIG. 53. Further, if the agent has entered any comments in the free-form fields titled “Special Additions” and “Special Exclusions” they will appear on the Certificate. Otherwise, the corresponding labels are suppressed. If the agent has entered any vehicles in the automobile section, any information in the property schedule section, or equipment in the marine section, that data is also displayed on the Certificate.

As on all pages, the system administrator's logo 310 is a navigation link back to the home page. Additionally, the certificate holder's name functions as a navigation link 5312 to take the holder back to the Certificate Selection Screen.

On the Certificate, the current date is displayed in the upper right hand corner after “view date” 5314, while the effective date the insurance information was entered is shown after “Data as of” 5316. This reflects the date entered by the holder on the Certificate Selection Screen, and defaults to the current date if the holder failed to specify another date.

The Compliance Report

A sample compliance report is shown in FIG. 12. As previously mentioned, the compliance report displays a table 1202 indicating whether every coverage for each insured viewed by a holder complies with the holder's requirements. The compliance report is organized by placing each insured on a separate row 1204 and each form of insurance in a separate column 1206.

When the “compliance report” button 4510 is clicked on the “Set Requirements” page (FIG. 45), the system automatically retrieves all insurance information for all insureds whose access code and passwords have been entered by this holder (limited by the Division restrictions selected by the holder) and compares the insurance information to the requirements specified by that holder. The comparison is made as of the effective date of data selected by the holder on the Certificate Selection Screen. The results are displayed in the compliance report. Should all parts of an insured's coverage satisfy the holder's requirements, the system displays “OK” in the corresponding cell 1208. If the insured's policy falls below the holder's requirements, “LOW” is shown 1210. The system displays “N/R” if no holder requirements exist, “N/C” 1212 if the insured has no coverage, “CNX” 1214 if the insured's policy has been cancelled, and “EXP” 1216 if the policy has expired. Alternative embodiments may use different abbreviations, or may include additional insurance states. The compliance report is the holder's instant reference to show the compliance status of each major coverage for each insured within the group defined by the Division criteria and with respect to the requirement set selected. The system defaults to requirement set 1, but if the holder wants to change which compliance set is used, he clicks on the “Add/Edit Requirements” button 1218 to go to the Add/Edit Requirements page, then clicks on the desired requirement set, then clicks on the compliance report button 4510.

From the compliance report screen, a user may click the “view expiration report” button 1220 to return to the exception report”web page (FIG. 52), the “Set Requirements” button 1218 to return to the “Requirements” page (FIG. 45), or the “View Certificates” 1222 button to display an insured's insurance certificates (FIG. 53).

The compliance report uses the name of each insured as a link 1224 to the corresponding exception report for each insured. Again with respect to the requirement set selected, if the holder sees that one or more coverages are “LOW” and wants to know why they do not comply, he simply clicks on the insured's name and reviews the exception report. He may then click on the “Deficiency Notice” button (not shown) to send notice to the insured. He may also continue through the same navigation described above to get to the certificate, if desired.

The Expiration Report

FIG. 13 displays an exemplary expiration report. The expiration report functions just as the compliance report, except that instead of evaluating compliance with the holder's requirements, the expiration report displays the expiration date (or cancellation date, if any) for each of the ten coverages. By default, the Expiration Report displays only those insureds (again limited by the Job/Branch/Location definition) who have a policy that has been cancelled, has expired, or will expire within thirty days of the current system date. Like the compliance report, the expiration report's names 1302 are links to the exception report. At the top of the expiration report is a button 1304 labeled “Full Expiration Report” which toggles to “expiration report 30 Day Limit”. Pressing this button alternately displays all insureds or only those expiring within thirty days, always including records with expired or cancelled policies.

Insurer Registration

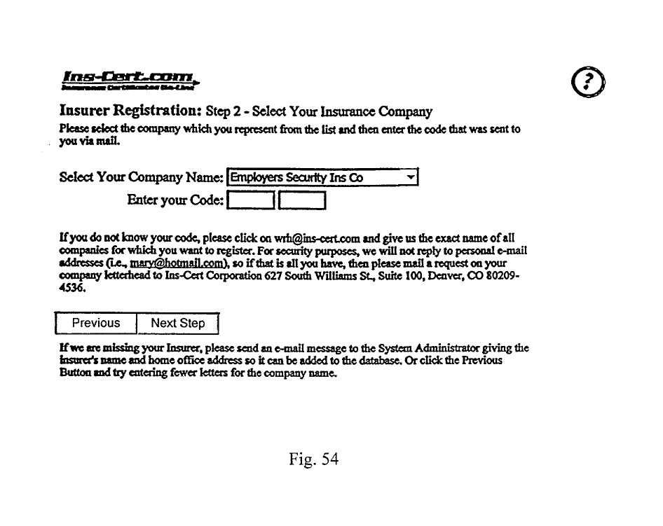

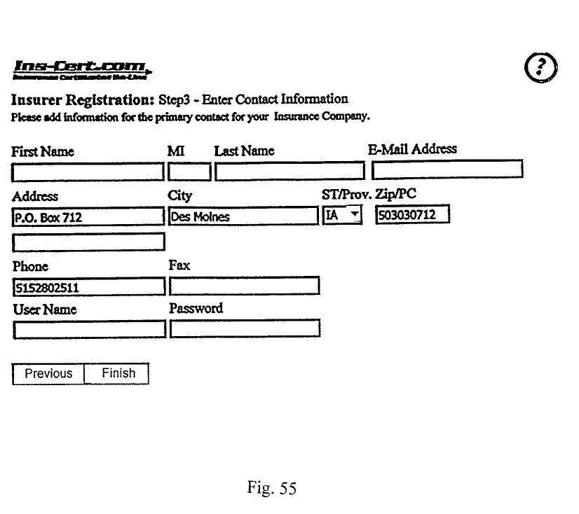

An Insurer may register with the system in a manner similar to that described with respect to the “Agent Registration” and “Holder Registration” sections, discussed above. The insurer registration process is carried out on web pages shown in FIGS. 54 and 55. The embodiment instructs insurers to select their company name from the list of all insurers already in the system, then enter a secret code in order to register an authorized contact person. The contact may choose a user name and password for future access. In the present embodiment, the Insurer is charged a $250 flat fee for registration. In alternative embodiments, a fee may be assessed on a transaction basis.

Insurer Functionality

The Insurer may add and edit Insurer information from the “Modify Registration” web page, shown in FIG. 54.

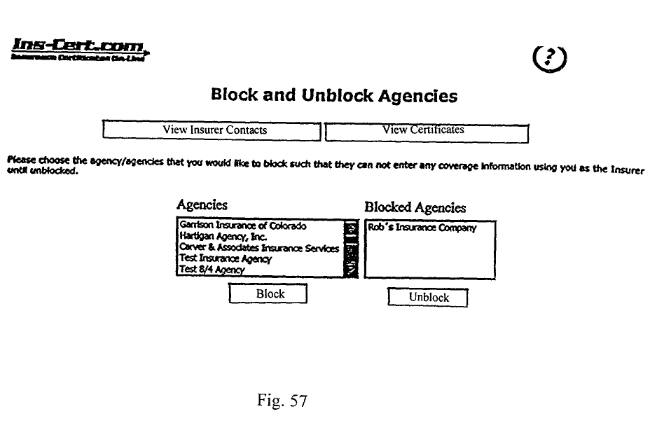

The Insurer may select from all registered agencies and/or agents and block or unblock agencies/agents from certifying that particular insurer. The Insurer performs this function from a “block agency” web page, as shown in FIG. 57. If blocked, any agent so blocked, or agent in a blocked agency, would see “--- BLOCKED” beside any blocked company appearing on the selection list, and that agent would be unable to select that Insurer.

The Insurer may view, as of current date or a selected date, a list of all insureds having coverage with that Insurer. The list is a copy of the Expiration Report, showing the expiration data of any coverage where the viewing Insurer equals the entering Insurer.

The Insurer may view any coverage on any certificate on which they are shown as the Insurer.

Conclusion

While the invention has been particularly shown and described with reference to various embodiments, those skilled in the art will realize upon reading the foregoing description various changes in structure, form, or detail which may be made without departing from the spirit of the invention. Accordingly, it the preceding description is meant by way of illustration and not limitation. The scope of the invention is set forth in the accompanying claims.

I claim:

1. A computer-implemented method for providing insurance information across a network, comprising:
receiving an access code from a user;
receiving a password from a user;
determining the user class of the user from the access code and password;
in the event that the user is an agent, permitting the agent to enter insurance information for an insured;
storing the insurance information along with the date and time of entry as a record;
generating an access code and password corresponding to the insured;
in the event that the user is a holder, permitting the holder to view insurance information for the insured corresponding to the holder's access code and password;
receiving a set of requirements from the holder; and
displaying an exception report to the holder, the exception report indicating which of the insured's insurance information violated the set of requirements.

2. The method of claim 1, wherein a holder may enter a plurality of access codes and passwords, each of the plurality of access codes and passwords corresponding to a single insured of a plurality of insureds.

3. The method of claim 2, further comprising:
permitting the holder to view insurance information for each of the plurality of insureds simultaneously; and
displaying a compliance report to the holder, the compliance report indicating which of each of the plurality of insureds' insurance information violates the set of requirements.

4. The method of claim 3, wherein the compliance report is presented as a table, the table having one row corresponding to each of the plurality of insureds and one column corresponding to each requirement of the set of requirements.

5. A computer-readable medium containing computer-implemented instructions which, when executed, perform the method of claim 4.

6. A computer-implemented method for retrieving and evaluating insurance information across a network, comprising:
inputting an access code and password for at least one insured;
receiving at least one insurance record comprised of at least one category of insurance coverage for the at least one insured;
inputting at least one user-specified insurance requirement;
comparing the insurance record to the user-specified insurance requirement; and
displaying the results of the comparison.

7. The method of claim 6, wherein the step of comparing the insurance record to the user-specified insurance requirement comprises:
determining whether the user has specified a coverage minimum for at least one insurance category;
determining from the at least one category of insurance coverage comprising the at least one insurance record whether the at least one insured's coverage meets or exceeds the coverage minimum;
creating a table, the table comprised of at least one row corresponding to each of the at least one insured and at least one column corresponding to each of the at least one categories of insurance coverage, the intersection of the at least one row and at least one column forming at least one cell; and
placing in the at least one cell an indicator corresponding to the results of determining whether the at least one insured's coverage meets or exceeds the coverage minimum.

8. The method of claim 7, wherein the indicator further indicates whether the at least one insured's coverage is cancelled or expired.

9. The method of claim 8, wherein the indicator indicating that the at least one insured's coverage is expired is the date of expiration.

10. A computer-readable medium containing computer-implemented instructions which, when executed, perform the method of claim 9.
